(19) United States
(12) Patent Application Publication
(10) Pub. No.: US 2024/0192981 A1
(43) Pub. Date: Jun. 13, 2024

(54) EXITLESS GUEST TO HOST NOTIFICATION

(71) Applicant: Intel Corporation, Santa Clara, CA (US)

(72) Inventors: Wei WANG, Shanghai (CN); Kun TIAN, Shanghai (CN); Gilbert NEIGER, Portland, OR (US); Rajesh SANKARAN, Portland, OR (US); Asit MALLICK, Saratoga, CA (US); Jr-Shian TSAI, Portland, OR (US); Jacob Jun PAN, Portland, OR (US); Mesut ERGIN, Portland, OR (US)

(21) Appl. No.: 18/285,212

(22) PCT Filed: Jun. 25, 2021
(86) PCT No.: PCT/CN2021/102317

§ 371 Date: Sep. 29, 2023

(51) Int. Cl. G06F 9/455; G06F 9/30

(52) U.S. Cl. CPC G06F 9/45558; G06F 9/30145; G06F 2009/45579

(57) ABSTRACT

Embodiments of exitless guest to host (G2H) notification are described. In some embodiments, G2H is provided via an instruction. An exemplary processor includes decoder circuitry to decode a single instruction, the single instruction to include a field for an opcode; and execution processing resources to execute the decoded single instruction according to the at least the opcode to cause an exitless guest to host notification from a virtual processor to a physical or virtual processor.

### BACKGROUND

Guest to host (G2H) notification is a common and frequent operation in the virtualization environment. A virtual device (e.g., virtio-net device) is usually emulated on the host and the virtual device driver (e.g., virtio-net driver) runs in the guest. The driver often needs to notify the device to process requests (e.g., sending a guest network packet).

### BRIEF DESCRIPTION OF DRAWINGS

Various embodiments in accordance with the present disclosure will be described with reference to the drawings:

FIG. 1 illustrates a system that is an information processing system including an embodiment of the present invention for inter-VM interrupts.

FIG. 2 illustrates embodiments of using VMFUNC to support G2H notification.

FIG. 3 illustrates a processor.

FIG. 4 illustrates embodiments of a PID and a UPID.

FIG. 5 illustrates an embodiment of method to process a VMFUNC.G2H instruction.

FIG. 6 illustrates embodiments of an EPT extension for exitless guest to host notification.

FIG. 7 illustrates embodiments of an EPT extension for exitless guest to host notification.

FIG. 8 illustrates embodiments of a method for using EPT-based exitless host notification.

FIG. 9 illustrates embodiments of an exemplary system.

FIG. 10 illustrates a block diagram of embodiments of a processor that may have more than one core, may have an integrated memory controller, and may have integrated graphics.

FIG. 11(A) is a block diagram illustrating both an exemplary in-order pipeline and an exemplary register renaming, out-of-order issue/execution pipeline according to embodiments of the invention.

FIG. 11(B) is a block diagram illustrating both an exemplary embodiment of an in-order architecture core and an exemplary register renaming, out-of-order issue/execution architecture core to be included in a processor according to embodiments of the invention.

FIG. 12 illustrates embodiments of execution unit(s) circuitry, such as execution unit(s) circuitry of FIG. 11(B).

FIG. 13 is a block diagram of a register architecture according to some embodiments.

FIG. 14 illustrates embodiments of an instruction format.

FIG. 15 illustrates embodiments of an addressing field.

FIG. 16 illustrates embodiments of a first prefix.

FIGS. 17(A)-(D) illustrate embodiments of how the R, X, and B fields of the first prefix are used.

FIGS. 18(A)-(B) illustrate embodiments of a second prefix.

FIG. 19 illustrates embodiments of a third prefix.

FIG. 20 illustrates a block diagram contrasting the use of a software instruction converter to convert binary instructions in a source instruction set to binary instructions in a target instruction set according to embodiments of the invention.

### DETAILED DESCRIPTION

The present disclosure relates to methods, apparatus, systems, and non-transitory computer-readable storage media for exitless guest to host notification.

Current G2H notifications are usually designed using virtual machine exits (VMExits). Typically, the guest driver writes to a device memory mapped input/output (MMIO) address (e.g., virtio or virtual NVMe device doorbell register located in the emulated base address register MMIO (BAR MMIO)), which is configured to cause an Extended Page Table (EPT) misconfiguration VMExit to a kernel based virtual machine (KVM), and then the KVM notifies the virtual device implementation via signaling the related event file descriptor (eventfd). The VMExit based G2H notification has an impact on performance.

Previous approaches do not target for guest to host notification. User interrupt and inter-processor interrupt (IPI) virtualization is used to deliver interrupts from one virtual CPU (vCPU) to another vCPU within the same guest. Inter-VM interrupt is used to deliver interrupts from a vCPU to another vCPU from a different guest. Embodiments described herein are used to send a notification from a guest vCPU to a host pCPU (physical CPU) that runs the target software (e.g., a host thread).

Detailed herein are a plurality of approaches to all for G2H notifications without requiring an VMExit. Some embodiments of an invoke VM function-based (VMFUNC-based) G2H notification solution. In particular, a guest executes a VMFUNC.G2H instruction (such as an VMFUNC instruction that specifies the leaf function of the guest to host notification) to notify a host thread without causing VMExits. VMFUNC.G2H functions by delivering a notification interrupt from a guest vCPU (i.e., non-root mode) to the target physical CPU (configured in a table by the hypervisor during setup) that runs the host software (e.g., a kernel or user thread).

While avoiding the VMExits contributes to better virtualization performance, VMFUNC.G2H requires the guest software (e.g., virtual device driver) to support the new VMFUNC.G2H instruction. In some embodiments, a VMFUNC.G2H instruction is not used, but rather an EPT-assistance based approach is used to provided exitless G2H notification that can be applied transparently to the guest.

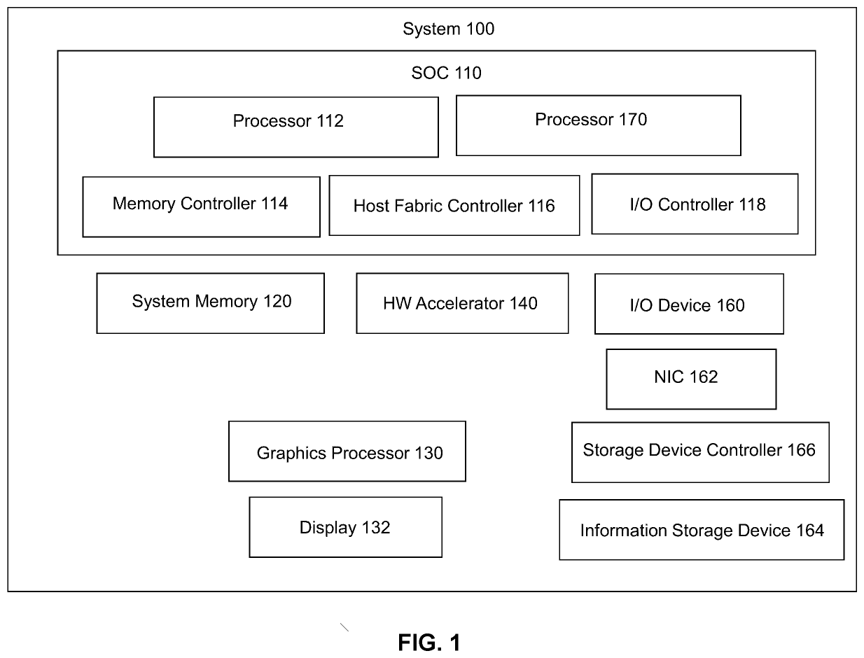

FIG. 1 illustrates system 100, an information processing system including an embodiment of the present invention for inter-VM interrupts. System 100 may represent any type of information processing system, such as a server, a desktop computer, a portable computer, a set-top box, a hand-held device such as a tablet or a smart phone, or an embedded control system. System 100 includes processor 112, memory controller 114, host fabric controller 116, I/O controller 118, system memory 120, graphics processor 130, and hardware accelerator 140.

Systems embodying the present invention may include any number of each of these components and any other components or other elements, such as peripherals and/or I/O devices (e.g., as described below). Any or all of the components or other elements in this or any system embodiment may be connected, coupled, or otherwise in communication with each other through any number of buses, point-to-point, or other wired or wireless interfaces or connections, unless specified otherwise. Any components or other portions of system 100, whether shown in FIG. 1 or not shown in FIG. 1, may be integrated or otherwise included on or in a single chip (a system-on-a-chip or SOC), die, substrate, or package, such as SOC 110.

System memory 120 may be dynamic random-access memory (DRAM) or any other type of medium readable by processor 112. System memory 120 may be used to provide a physical memory space from which to abstract a system memory space for system 100. The content of system memory space 200, at various times during the operation of system 100, may include various combinations of data, instructions, code, programs, software, and/or other information stored in system memory 120 and/or moved from, moved to, copied from, copied to, and/or otherwise stored in various memories, storage devices, and/or other storage locations (e.g., processor caches and registers) in system 100.

System memory space 120 may be logically organized, addressable as, and/or otherwise partitioned (e.g., using any known memory management, virtualization, partitioning, and or other techniques) into regions of one or more sizes. In various embodiments, such regions may be 4K-byte pages, so, for convenience, such regions may be referred to in this description as pages; however, the use of the term “page” in this description may mean any size region of memory.

System memory space 120 may contain VM control structure (VMCS) corresponding to a sending VM, inter-VM-IPI instruction in guest software to be executed by the sending VM, inter-VM-IPI table, a virtual local Advanced Programmable Interrupt Controller (APIC) page, a PID, and VMCS corresponding to a target VM, all of which are defined and/or described below.

Memory controller 114 may represent any circuitry or component for accessing, maintaining, and/or otherwise controlling system memory 120. Host fabric controller 116 may represent any circuitry or component for controlling an interconnect network or fabric through which processors and/or other system components may communicate. Graphics processor 130 may include any processor or other component for processing graphics data for display 132. Hardware accelerator 140 may represent any cryptographic, compression, or other accelerator to which a processor may offload functionality such as the hardware acceleration of encryption or compression algorithms.

I/O controller 118 may represent any circuitry or component, such as a chipset component, including or through which peripheral, input/output (I/O), or other components or devices, such as I/O device 160 (e.g., a touchscreen, keyboard, microphone, speaker, other audio device, camera, video or other media device, motion or other sensor, receiver for global positioning or other information, etc.), network interface controller (NIC) 162, and/or information storage device 164, may be connected or coupled to processor 112. Information storage device 164 may represent any one or more components including any one or more types of persistent or non-volatile memory or storage, such as a flash memory and/or a solid state, magnetic, or optical disk drive, and may include its own information storage device controller 166.

Processor 112 may represent all or part of a hardware component including one or more processors or processor cores integrated on a single substrate or packaged within a single package, each of which may include multiple execution threads and/or multiple execution cores, in any combination. Each processor represented as or in processor 112 may be any type of processor, including a general purpose microprocessor, such as a processor in the Intel® Core® Processor Family or other processor family from Intel® Corporation or another company, a special purpose processor or microcontroller, or any other device or component in an information processing system in which an embodiment of the present invention may be implemented. Processor 112 may be architected and designed to operate according to any ISA.

System 100 and/or SOC 110 may include one or more additional processors or processor cores (one of which is represented as processor 170), each or any of which may be any type of processor or processor core, including a processor or processor core identical to, compatible with, in the same family as, sharing any portion of the same ISA with, and/or differing in any way from processor 112.

In some embodiments, a host posted interrupt feature is used by a sending agent (e.g., the sender CPU'S microcode (ucode) when guest executes VMFUNC.G2H) to post a request bit in (U)PID.PIR (per physical CPU) before delivering a notification interrupt to the target physical CPU. This allows better scalability as many host threads can share a single notification vector (but distinguished by unique request bits posted in (U)PID.PIR).

This allows the virtualization software to run with better performance. For example, the device emulation (e.g., virtual network cards, virtual block devices) will be more efficient, because the virtual device driver (run in guest) to the virtual device (run on host) notification does not cause VMExits, and this can accordingly increase the guest network/disk performance).

In some embodiments, the sender side VMFUNC extension is used for inter-VM notification with the notification destination of VMFUNC.G2H a host kernel thread or host user thread. The receiver side uses, in some embodiments, a host posted interrupt design. This is for enhancing the guest to host kernel thread notification with better scalability. For the guest to host user thread notification, it follows the existing host side user interrupt notification process.

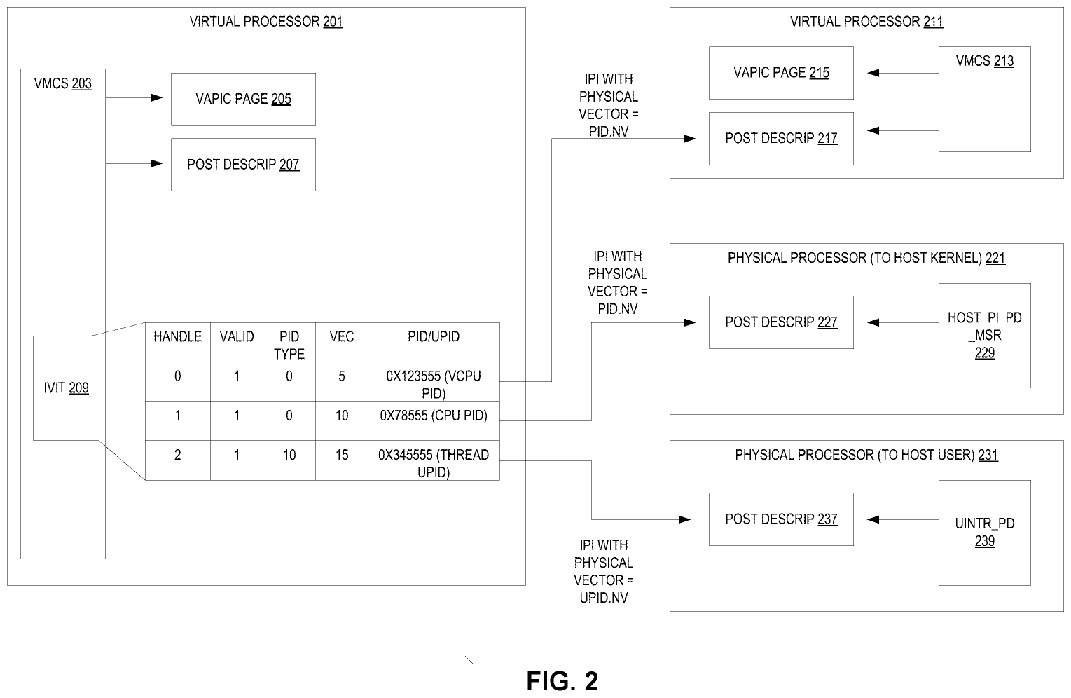

FIG. 2 illustrates embodiments of using VMFUNC to support G2H notification. From within a VM, It may be desirable for guest software running in the VM (to be referred to as a sending VM) to send a notification or interrupt to a different VM, virtual processor, virtual device, or other target (any of which, for convenience but without limitation, may be referred to as a target VM). An attempt to send a notification or interrupt from a sending VM to a target VM may (e.g., based on controls set in a VMCS) cause a VM exit, which may provide for a VMM, hypervisor, or other host software (each of which may be referred to as a VMM for convenience) to Intercept, assist with, and/or perform the sending of the notification/interrupt. To avoid the overhead of the VM exit involved in this scenario, embodiments of the present invention provide for an instruction (inter-VM-IPI) to be used by a guest running in a sending VM to allow a notification/interrupt (an inter-VM interrupt) to be sent to a target VM without causing a VM exit from the sending VM or other transfer of control to a VMM or out of non-root mode.

Note that the name of the inter-VM-IPI instruction and the VMFUNC instruction referred to below are provided merely for convenience, and embodiments of the present invention may include such an instructions having any names desired. In various embodiments, one or more variants of these instructions may be added to an existing ISA as enhancements, extensions, leaves, or other variants of one or more existing instructions or opcodes. Also note that a processor's execution of and/or response to an inter-VM-IPI instruction may also or instead be performed (and/or possibly referred to below as an inter-VM-IPI operation or function) in response to or in connection with other events (e.g., a write to or setting of bits of a command, model-specific, or other register).

In various embodiments of the present invention, an inter-VM-IPI instruction may be a leaf of the VMFUNC instruction or opcode that allows functions provided to support virtualization to be called from within a VM, without causing a VM exit. A first parameter associated with the VMFUNC instruction (e.g., the value in the EAX register in a processor in the Intel® Core® Processor Family) may specify that the function to be invoked is an inter-VM-IPI function (for example, the value of ‘1’ in the EAX register may specify the inter-VM-IPI function, which may therefore be referred to as VMFUNC(1)). A second parameter associated with the VMFUNC instruction (e.g., the value in the ECX register in a processor in the Intel® Core™ Processor Family) may be used as a handle to specify the target VM, as further described below. If the specified handle is invalid or does not exist, the VMFUNC(1) instruction may result in a VM exit, a virtualization exception (without a VM exit), or another known error handling approach.

The virtualization functionality and support described above may be subject to any number and/or level of enablement controls. In an embodiment, a global virtualization control, may be used to enable or disable the use of non-root mode. A secondary controls activation control (e.g., a designated bit in a designated VM-execution control field of the VMCS) may be used to enable a secondary level of controls for execution in non-root mode. The secondary controls may include a VM function enable control (e.g., a designated bit in a designated VM-execution control field of the VMCS) that may be used to enable the use of the VMFUNC instruction. A VMFUNC(1) control (e.g., a designated bit in a designated VM-function control field of the VMCS) may be used to enable the use of inter-VM-IPIs. Note that in this embodiment, the use of inter-VM-IPIs is not enabled unless all of the bits described above are set.

Furthermore, note that a processor may be designed, configured, and/or programmed such that the VMFUNC instruction, a particular leaf of the VMFUNC instruction (e.g., leaf 1), and/or the inter-VM-IPI instruction may be executable from one or more privilege levels. For example, processor 200 and/or a particular VM may be configured (e.g., by a VMM) to allow an inter-VM-IPI instruction to be executed, without causing a VM exit, from within a supervisor mode supported by the processor (e.g., ring-0) and a user mode supported by the processor (e.g., ring-3).

As shown, a virtual processor 201 (which runs on some physical processor which, in some embodiments, is not one of the physical processors shown) utilizes a virtual machine control structure (VMCS) 203 during virtual machine execution. The VMC 203 is used in the management of transitions into and out of a virtual machine execution non-root operation (sometimes called VM entry and VM exit). A VMM can use a different VMCS for each virtual machine that it supports. For a virtual machine with multiple logical processors (virtual processors), the VMM can use a different VMCS for each virtual processor.

A virtual (logical) processor associates a region in memory with each VMCS. This region is called the VMCS region. Software references a specific VMCS using the physical address of the region (a VMCS pointer). A logical processor may maintain a number of VMCSs that are active. The processor may optimize VM operation by maintaining the state of an active VMCS in memory, on the processor, or both. At any given time, at most one of the active VMCSs is the current VMCS.

As shown, a least the sending VM's (virtual processor 201) VMCS 203 includes an inter-VM-IPI (IVIT) structure. This structure includes a plurality of fields per entry. In some embodiments, these fields include one or more of a handle field, validity field, a PID type field, a vector field, and a PID/UPID field.

For example, handle field may include bits to store a handle value to be used to as an entry number, address, index, pointer, or other locator of or to a particular entry in the table such that a handle value specified by an inter-VM-IPI instruction. The validity field indicates if the entry is valid or not. The PID Type specifies if the receiver CPU (virtual or physical) is using a posted interrupt descriptor (PID) (or other host posted interrupt format) or a user posted interrupt description (UPID) format. The PID/UIPD address field stores an address of a PID or UPID such that a PID/UPID to be used to post an interrupt to a target VM may be found. The vector field stores a virtual interrupt vector corresponding to the particular notification and/or interrupt to be sent to the target VM.

Each VMCS 203 and 213 may include a first pointer (e.g., vAPIC pointer 205 and 215) to a first data structure (e.g., virtual local APIC page) to be used in the virtualization of a local interrupt controller and a second pointer (e.g., PID pointer 207 and 217) to a second data structure (e.g., PID) to be used, in some embodiments, in the posting of interrupts to a virtual processor.

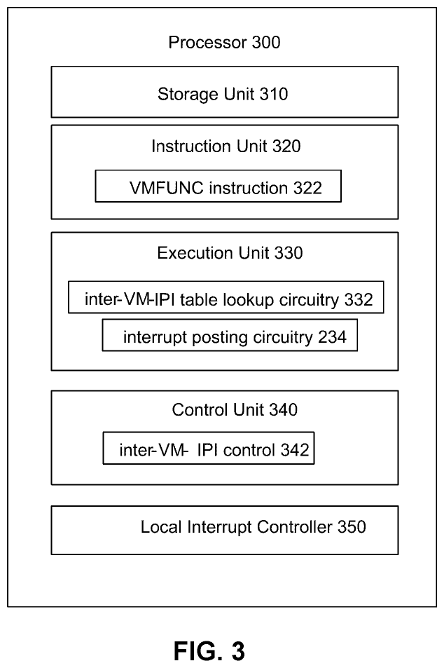

FIG. 3 illustrates processor 300, which may represent an embodiment of processor 112 and/or processor 170 in FIG. 1 or an execution core of a multicore processor embodiment of processor 112 and/or processor 170 in FIG. 1. Processor 300 may include storage unit 310, instruction unit 320, execution unit 330, control unit 340, and local interrupt controller 350. Processor 300 may also include any other circuitry, structures, or logic not shown in FIG. 3.

Storage unit 310 may include any combination of any type of storage usable for any purpose within processor 300; for example, it may include any number of readable, writable, and/or read-writable registers, buffers, and/or caches, implemented using any memory or storage technology, in which to store capability information, configuration information, control information, status information, performance information, instructions, data, and any other information usable in the operation of processor 300, as well as circuitry usable to access such storage and/or to cause or support various operations and/or configurations associated with access to such storage.

Instruction unit 320 may include any circuitry, logic, structures, and/or other hardware, such as an instruction decoder, to fetch, receive, decode, interpret, schedule, and/or handle instructions (including VMFUNC.G2H instruction 322, described below) to be executed by processor 300. Any instruction format may be used within the scope of the present invention; for example, an instruction may include an opcode and one or more operands, where the opcode may be decoded into one or more micro-instructions or micro-operations for execution by execution unit 330. Operands or other parameters may be associated with an instruction implicitly, directly, indirectly, or according to any other approach.

Execution unit 330 may include any circuitry, logic, structures, and/or other hardware, such as arithmetic units, logic units, floating point units, shifters, etc., to process data and execute instructions, micro-instructions, and/or micro-operations. Execution unit 330 may represent any one or more physically or logically distinct execution units. Execution unit 330 may include inter-VM-IPI table lookup circuitry 332 to use a handle from an inter-VM-IPI instruction to find a PID address and an interrupt vector in an inter-VM-IPI table, as described below. Execution unit 330 may also include interrupt posting circuitry 334 to post an interrupt, as described below.

Control unit 340 may include any microcode, firmware, circuitry, logic, structures, and/or hardware to control the operation of the units and other elements of processor 300 (including inter-VM-IPI control 342) and the transfer of data within, into, and out of processor 300. Control unit 340 may cause processor 300 to perform or participate in the performance of method embodiments of the present invention, such as the method embodiments described below, for example, by causing processor 300, using execution unit 330 and/or any other resources, to execute instructions received by instruction unit 320 and micro-instructions or micro-operations derived from instructions received by instruction unit 320. The execution of instructions by execution 330 may vary based on control and/or configuration information stored in storage unit 310.

Local interrupt controller 350 may include any circuitry, logic, structures, and/or other hardware to receive, generate, prioritize, deliver, hold pending, or otherwise control or manage interrupt requests. For example, local interrupt controller 350 may be a local APIC in a processor in the Core® Processor Family from Intel Corporation. Embodiments of the present invention may include virtualization of local interrupt controller 350, according to any known approach, to provide a virtual local interrupt controller for each virtual processor abstracted from processor 300.

Processor 300 may support virtualization according to any approach. For example, processor 300 may operate in two modes—a first (root) mode in which software runs directly on the hardware, outside of any virtualization environment, and a second (non-root) mode in which software runs at its intended privilege level, but within a virtual environment hosted by a VMM running in the first mode. In the virtual environment, certain events, operations, and situations, such as interrupts, exceptions, and attempts to access privileged registers or resources, may be intercepted, i.e., cause the processor to exit the virtual environment (a VM exit) so that the VMM may operate, for example, to implement virtualization policies. The processor may support instructions for establishing, entering (a VM entry), exiting, and maintaining a virtual environment, and may include register bits or other structures that indicate or control virtualization capabilities of the processor.

In describing embodiments of the present invention, any platform, system, or machine, including the “bare metal” platform shown as system 100 in FIG. 1 as well as any VM or other container abstracted from a bare metal platform, from which one or more VMs may be abstracted may be referred to as a host or host machine, and each VM abstracted from a host machine may be referred to as a guest or guest machine. Accordingly, the term “host software” may mean any hypervisor, VMM, OS, or any other software that may run, execute, or otherwise operate on a host machine and create, maintain, and/or otherwise manage one or more VMs, and the term “guest software” may mean any OS, system, application, user, or other software that may run, execute, or otherwise operate on a guest machine. Note that in a layered container architecture, software may be both host software and guest software. For example, a first VMM running on a bare metal platform may create a first VM, in which a second VMM may run and create a second VM abstracted from the first VM, in which the case the second VMM is both host software and guest software.

Processor 300 may control the operation of one or more VMs according to data stored in one or more VMCSs. A VMCS is a data structure that may contain state of one or more guests, state of a host, execution control information indicating how a VMM is to control operation of a guest or guests, execution control information indicating how VM exits and VM entries are to operate, information regarding VM exits and VM entries, and any other such information. Processor 300 may read information from a VMCS to determine the execution environment of a VM and constrain its behavior. Embodiments may use one VMCS per VM or any other arrangement. Each VMCS may be stored, in whole or in part, in system memory 120, and/or elsewhere, such as being copied to a cache memory of a processor.

According to embodiments of the present invention, a VMCS (e.g., VMCS 250) may include a first pointer (e.g., vAPIC pointer 252) to a first data structure (e.g., virtual local APIC page 230) to be used in the virtualization of a local interrupt controller (e.g., local interrupt controller 350) and a second pointer (e.g., PID pointer 254) to a second data structure (e.g., PID 240) to be used in the posting of interrupts to a virtual processor. Virtualization of a local interrupt controller and posting of interrupts to a virtual processor may each be implemented according to any known approach, such that the resources of each VM may include one or more virtual processors, each with a corresponding virtual local interrupt controller, such that interrupts may be sent to each VM abstracted from system 100.

From within a VM, it may be desirable for guest software running in the VM (to be referred to as a sending VM) to send a notification or interrupt to a different VM, virtual processor, virtual device, or other target (any of which, for convenience but without limitation, may be referred to as a target VM). An attempt to send a notification or interrupt from a sending VM to a target VM may (e.g., based on controls set in a VMCS) cause a VM exit, which may provide for a VMM, hypervisor, or other host software (each of which may be referred to as a VMM for convenience) to intercept, assist with, and/or perform the sending of the notification/interrupt. To avoid the overhead of the VM exit involved in this scenario, embodiments of the present invention provide for an instruction (inter-VM-IPI) to be used by a guest running in a sending VM to allow a notification/interrupt (an inter-VM interrupt) to be sent to a target VM without causing a VM exit from the sending VM or other transfer of control to a VMM or out of non-root mode.

The virtualization functionality and support described above may be subject to any number and/or level of enablement controls. In an embodiment, a global virtualization control, (e.g., a designated bit in a designated control register in storage unit 310) may be used to enable or disable the use of non-root mode. A secondary controls activation control (e.g., a designated bit in a designated VM-execution control field of the VMCS) may be used to enable a secondary level of controls for execution in non-root mode. The secondary controls may include a VM function enable control (e.g., a designated bit in a designated VM-execution control field of the VMCS) that may be used to enable the use of the VMFUNC instruction. A VMFUNC(1) control (e.g., a designated bit in a designated VM-function control field of the VMCS) may be used to enable the use of inter-VM-IPIs. Note that in this embodiment, the use of inter-VM-IPIs is not enabled unless all of the bits described above are set.

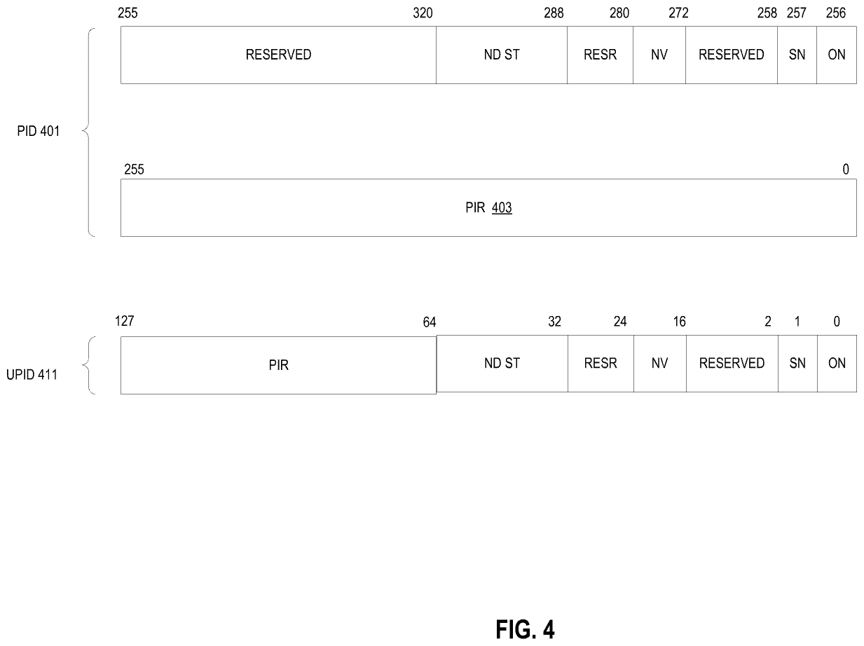

FIG. 4 illustrates embodiments of a PID and a UPID. Software, such as a VMM, may allocate a PID for each virtual processor that may be the target of an inter-VM-IPI. The general idea is that an agent “posts” the interrupt in a data structure (posted-interrupt descriptor or PID) and then sends an interrupt (notification) to the logical processor on which the target virtual processor is operating. When that logical processor receives the notification, it uses information in the PID to deliver the virtual interrupt to the virtual processor.

Each PID may have a format as illustrated. In this illustration, the PID 401 is a 512-bit value. A 256-bit posted interrupt request (PIR) field 403 is used to identify interrupts. For example, in some embodiments, each bit of the PIR 403 may correspond to one of 256 virtual interrupt vectors for the virtual processor corresponding to the PID. Each bit of the PIR 403 may be set to post an interrupt request for a corresponding virtual interrupt vector (e.g., the virtual interrupt vector specified by vector field). One or more fields are used indicate attributes of a notify event to be used to inform a VMM of pending posted interrupts. In an embodiment, the event used to notify a VMM that posted interrupts are pending may be a physical interrupt request to a physical processor. Therefore, using a physical processor that may support over one hundred physical interrupts, embodiments of the present invention may provide for over one hundred virtual processors per physical processor.

Bits 319:256 provide notification information, organized as follows: bit 256 is an outstanding notification (ON) bit and when set there is a notification outstanding for one or more posted interrupts in PIR; bit 257 is a suppress notify (SN) bit and the setting of this bit directs agents not to send notifications; bits 279:272 are a notify vector (NV); and bits 319:288 delineate a notify destination (NDST) wherein notifications will be directed to this physical APIC ID.

The UPID 411 has a similar format, but is more compressed in that it has a smaller PIR in some embodiments.

As shown, the virtual processor 201 may communicate with other virtual processors (e.g., virtual processor 211) and/or physical processors (e.g., 221 and/or 231). The physical processors 221 and/or 231 include a posted descriptor 227 and 237. In some embodiments, one or more of the processors 221 and/or 231 includes a model specific register (MSR). For example, a UNITR_PD MSR 239 which is to hold a current value of UPIADDR which is the linear address of a UPID.

In the example of FIG. 2, the second entry of the IVIT 209 is set up by the hypervisor for the guest to deliver an interrupt to a physical CPU to be handled in root-mode Ring0 (i.e. a host kernel interrupt handler), and the third entry is set up to deliver an interrupt to a physical CPU to be handled in root-mode Ring3 (i.e. a host user interrupt handler).

When the guest software running on this vCPU 201 executes a VMFUNC.G2H(TID—Target ID) instruction the following is performed. In some embodiments, the TID is provided as an operand (such as a data stored in an identified register or memory location) or as an immediate to the instruction. In some embodiments, the VMFUNC.G2H is a leaf of a VMFUNC instruction wherein the G2H functionality is identified by a value stored in an implicit register (e.g., EAX). In some embodiments, the VMFUNC.G2H is an instruction independent of VMFUNC.

First, the TID is used to index into the IVIT 209 (e.g., using the handle) to get the destination PID or UPID. For example, TID=1, the PID located at physical address 0x78555 is retrieved. Second, the vCPU 201 sets the IVIT.vector (i.e., 10) of the entry into the (U)PID.PIR 'INV27 of the destination. The vCPU 201 then sends an IPI with physical vector=PID.NV (Host PI notification vector assigned by the host kernel) to the destination CPU 221 (i.e., the destination CPU APIC ID is PID.NDST). In some embodiments, the notification-information field in the PID is set. Finally, the destination CPU 221 invokes the interrupt handler corresponding to the notification vector (as other regular interrupt handling). The handler can be programmed to wake up the corresponding host thread via detecting the request bits set in (U)PID.PIR. A logical processor recognizes as a notification any interrupt with the posted-interrupt notification vector (a field in the VMCS). When this occurs, the logical processor atomically reads and clears the current PID's PIR field as well as its ON bit. It then causes the virtual interrupts posted in the PIR field to be delivered to the virtual processor (using the virtual-interrupt delivery feature).

In the illustration, when TID=2, then the sender CPU will get a UPID located at physical address 0x34555, set IVIT.vector (i.e., 15) into U(U)PID.PIR, and send an IPI with physical vector=PID. UINV to the destination CPU (APIC ID is UPID.NDST). Then the destination CPU 231 will handle the interrupt.

The feature is termed with “posted”, because the sender agent (e.g., the CPU ucode when guest executes VMFUNC.G2H) posts the request bit in a posted interrupt descriptor, more precisely, the 256-bit posted interrupt request (PIR) filed, before delivering a notification interrupt to the CPU that runs the target software (e.g., a host kernel thread).

Though this feature is intended for G2H notification, it could also be used simply on the host as a solution to scaling interrupt vector number. For example, the sender agent could be a host thread (or VT-d engine) which posts a bit on (U)PID.PIR and then deliver a notification interrupt to the target physical CPU.

In some embodiments, a new MSR (IA32_HOST_PI_PD) holds the current value of Host PID descriptor, which uses the same format as shown in FIG. 2 above. In some embodiments, the PID descriptor is pointed to by a software pointer (not necessarily a MSR). Handling of a host PI is no different than handling other regular interrupts. The host software assigns a vector (one from the user defined vectors from 32-255) to be a host PI notification vector and adds an interrupt handler (same as other interrupt handler) to the related IDT entry. The notification interrupt handler detects a specific request via the (U)PID.PIR and invokes the related callback to handle it. There may be multiple kernel threads sleeping on the same CPU and waiting to be woken up. Each of the threads can be assigned a request bit in (U)PID.PIR, and the sender CPU sets the related bit in PIR and send an IPI with the notification vector.

As an example, assume there is a host thread for serving the guest network requests (e.g., assigned bit 0 from (U)PID.PIR, then PID.vector is set to 0) and another host thread for serving the guest disk requests (e.g., assigned bit 1 from (U)PID.PIR, then PID.vector is set to 1). When the guest network driver wants to notify the host network servicing thread to send out network packets from its network ring, it reads the IVIT entry from an MMIO register which is designed to get TID and emulated by the host, for example, it gets TID=5. The guest driver executes VMFUNC.G2H(5), then the sender CPU finds the PID address from the fifth entry in IVIT and sets the PID.vector (i.e., 0) in (U)PID.PIR and sends a PID.NV to the target CPU (i.e. PID.NDST, which is updated when the target network serving thread gets scheduled on that physical CPU) if PID.SN (suppress notification bit) is not set. The notification interrupt handler finds bit 0 is set in (U)PID.PIR and finds that it corresponds to the network servicing thread (e.g., via a request-bit to thread mapping), then it wakes up the network serving thread to read packets from the guest network ring. For the disk usage, the guest disk driver gets a different TID from the host and the working flows is the same as above, but with a different request bit (bit 1) set in (U)PID.PIR and the notification interrupt handler will wake up the disk servicing thread to handle guest disk requests.

The above allows 256 host threads when (U)PID.PIR 256 bits to share a single notification vector. This can be further extended via adding more IA32_HOST_PI_PD[i] MSRs, with each loading a different PID, and a different notification vector assigned and set to PID[i].NV. The sender (either a host kernel thread or a guest via CPU microcode operating with an IVIT entry) is assigned the corresponding PID and request bit in PIR during the initial negotiation setup.

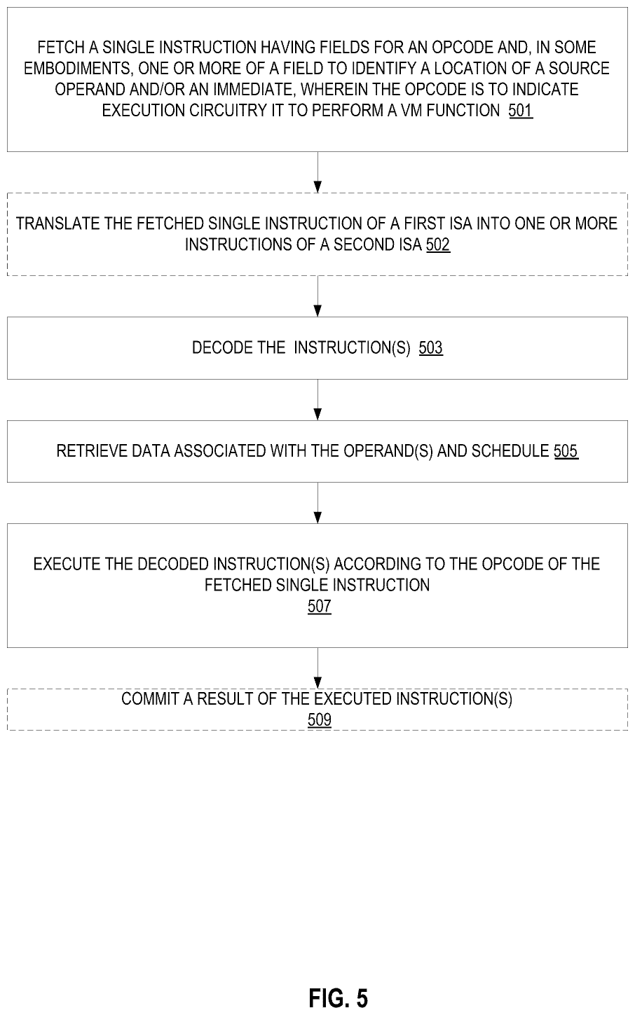

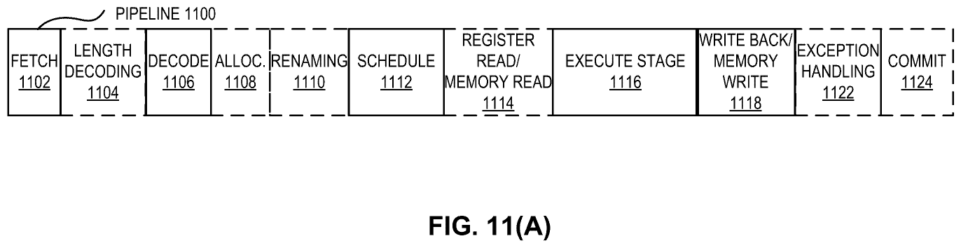

FIG. 5 illustrates an embodiment of method to process a VMFUNC.G2H instruction. For example, a processor core as shown in FIG. 11(B), FIG. 3, a pipeline as detailed below, etc. performs this method. In some embodiments, the processor core includes an instruction translator to perform an instruction set architecture (ISA) translation. In other embodiments, a software based translation is used.

In various embodiments of the present invention, the VMFUNC.G2H instruction is a leaf of a VMFUNC instruction, or a separate opcode, that allows functions provided to support virtualization to be called from within a VM without causing a VM exit. In some embodiments, a first parameter associated with the VMFUNC instruction (e.g., the value in the EAX register in a processor in the Intel® Core® Processor Family) specifies that the function to be invoked is an inter-VM-IPI function (for example, the value of ‘X’ in the EAX register may specify the G2H function, which may therefore be referred to as VMFUNC(X)). In some embodiments, a second parameter associated with the VMFUNC instruction (e.g., the value in the ECX register in a processor in the Intel® Core® Processor Family) stores a handle to specify the target VM (TID), as further described below. If the specified handle is invalid or does not exist, the VMFUNC(X) instruction may result in a VM exit, a virtualization exception (without a VM exit), or another known error handling approach. In some embodiments, an explicit operand (e.g., whose location is identified by the instruction or encoded as an immediate) provides the TID.

At 501, a single instruction is fetched. In some embodiments, the single instruction includes fields for an opcode and, in some embodiments, one or more of a field to identify a location of a source operand and/or an immediate, wherein the opcode is to indicate instruction processing resources (e.g., execution unit 330, control unit 340, local interrupt controller 350, instruction unit 322, etc.) is/are to perform an VM function.

In some embodiments, the VM function is provided by a leaf. In some embodiments, the VM function is indicated solely by the opcode. The VM function in this scenario is to perform an exitless G2H notification.

In some embodiments, the identified source operand is a register or memory location that stores a TID. In some embodiments, the TID is provided by an implicit register or memory location. In some embodiments, the TID is provided by the immediate.

The instruction processing resources are to use the TID to index into the IVIT of the guest VM to get the destination PID or UPID. Then the instruction processing resources sets IVIT.vector into a (U)PID.PIR of the destination. The instruction processing resources then sends an IPI with physical vector=PID.NV (Host PI notification vector assigned by the host kernel) to the destination CPU as identified by the PID or UPID. Note that after the execution has completed, in some embodiments, the destination CPU will invoke the interrupt handler corresponding to the notification vector (as other regular interrupt handling). The handler can be programmed to wake up the corresponding host thread via detecting the request bits set in (U)PID.PIR.

In some embodiments, the fetched instruction of the first instruction set architecture is translated into one or more instructions of a second instruction set architecture at 502.

The single instruction of the first instruction set architecture or the one or more translated instructions of the second instruction set architecture are decoded at 503.

Data values associated with the source operands of the decoded instruction are retrieved and the instruction(s) scheduled at 505. For example, when one or more of the source operands are memory operands, the data from the indicated memory location is retrieved.

At 507, the decoded single instruction of the first instruction set architecture or the decoded instruction(s) of the second instruction set is/are executed by instruction processing resources such as that detailed herein (e.g., one or more of the execution unit 330, control unit 240, instruction unit 320, etc.) to perform the operations indicated by the opcode of the single first instruction of the first instruction set architecture.

In some embodiments, the instruction is committed or retired at 509.

In some embodiments, an exitless guest to host notification mechanism with extended page table (EPT) assistance is used in lieu of an instruction. In particular, a new bit in a EPT leaf or pointer (e.g., bit 59) is defined as the notification bit, and the bit is set by the hypervisor during the guest doorbell MMIO address setup. A guest's writing to the legacy doorbell MMIO address gets translated by EPT as normal (e.g., get the leaf entry from a translation lookaside buffer (TLB)), and the EPT walking helps to get the TID which is an index used to get a related IVIT entry to be used to send an IPI. With TID, the processor (for example, microcode of the processor) finds the related IVIT table entry and delivers a notification interrupt to the target physical CPU (configured in a table by the hypervisor or VMM during setup) that runs the host software (e.g., a kernel or user thread). A host posted interrupt feature is used to have the sender post a request bit in (U)PID.PIR (per physical CPU) before delivering a notification interrupt to the target physical CPU as noted above. This allows better scalability as many host threads can share a single notification vector (but distinguished by unique request bits posted in (U)PID.PIR).

When the bit has not been set (e.g., guest's first writes to the doorbell address) and the guest writes to the doorbell MMIO address, it causes an EPT violation VMExit to the hypervisor (as the physical page isn't mapped by the EPT leaf entry) and the hypervisor device emulation recognizes that this is a doorbell MMIO access. With the EPT assistance approach described, a guest is not aware of the TID as the TID is configured via EPT by the hypervisor.

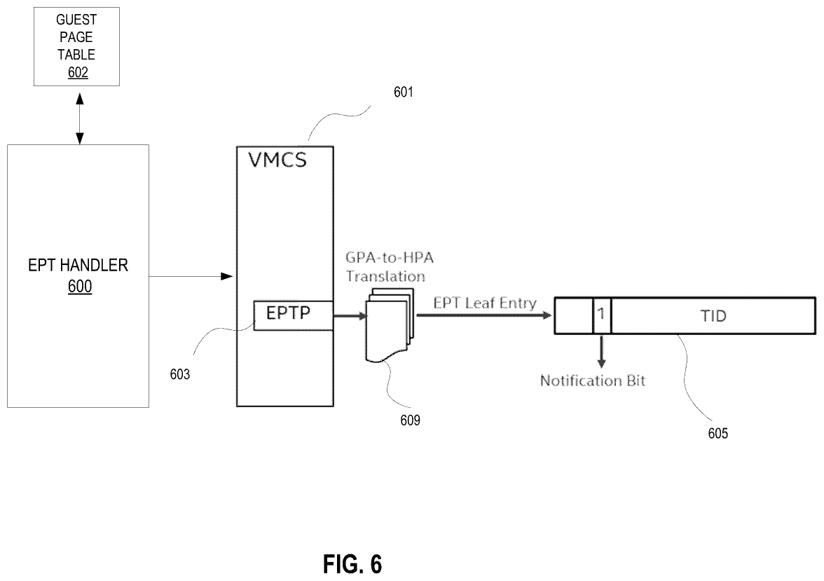

FIG. 6 illustrates embodiments of an EPT extension for exitless guest to host notification. An EPT handler 600 (software, hardware, or a combination thereof) coordinates the acts detailed below. As shown, a VMCS 601 uses an extended page table pointer (EPTP) 603 to point to a guest physical address (e.g., doorbell MMIO GPA) used by an EPT leaf entry. The guest doorbell MMIO virtual address to guest physical address translation is provided via a guest page table (outside of VMCS) 602. The EPT is used for the guest physical to host physical address translation. The EPT leaf entry 605 is obtained via a GPA-to-HPA translator 609 such as a TLB cache entry (a dedicated TLB for the G2H notification address translation is implemented in the processor in some embodiments) or an EPT page table walk when a TLB miss occurs. The EPT leaf entry 605 includes the notification bit and TID.

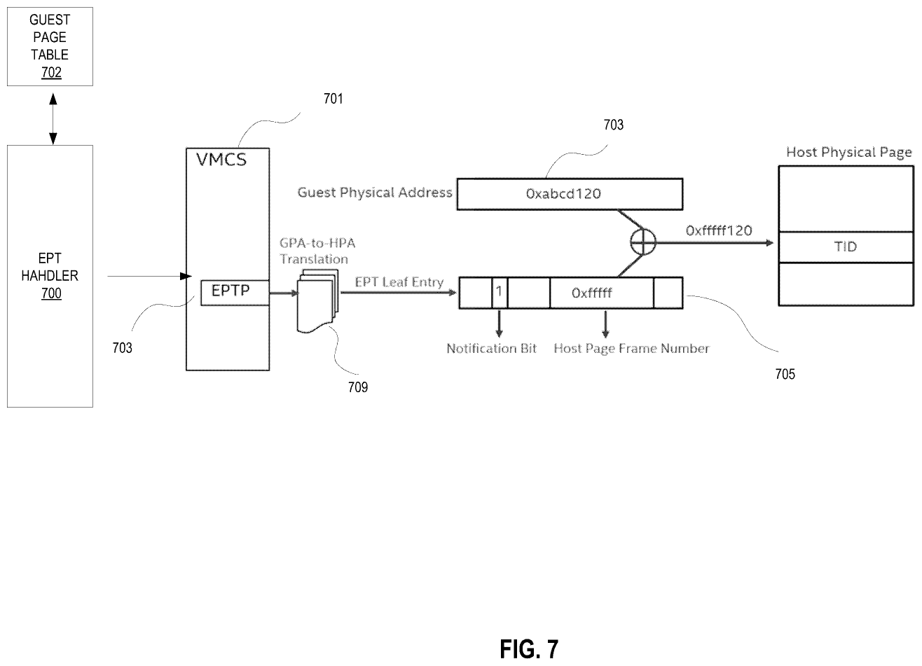

FIG. 7 illustrates embodiments of an EPT extension for exitless guest to host notification. An EPT handler 700 (software, hardware, or a combination thereof) coordinates the acts detailed below. In this illustration, a VMCS 701 uses an extended page table pointer (EPTP) 703 to point to a guest physical address (e.g., doorbell MMIO GPA) used by an EPT leaf entry. The guest doorbell MMIO virtual address to guest physical address translation is provided via a guest page table (outside of VMCS) 702. The EPT is used for the guest physical to host physical address translation. The EPT leaf entry 705 is obtained either via a GPA-to-HPA translator 709 such as a TLB cache entry (a dedicated TLB for the G2H notification address translation is implemented in the processor in some embodiments) or an EPT page table walk when a TLB miss occurs.

The EPT leaf entry 705 includes the notification bit and a host page frame number. The host page frame number is XOR'd with the guest physical address 707 to generate an address of the TD in a host physical page 709.

To set either usage up, the hypervisor of the VM 1) allocates an available entry from the IVIT table and configures the IVIT entry (the table and entries have been detailed above), 2) acquires an EPT leaf entry corresponding to the MMIO GPA (Guest Physical Address) and sets the notification bit; and 3) with the approach in FIG. 6, stores the TID in bits [15:0] of the EPT leaf entry or with the approach of 7 stores the TID in the physical page that is mapped by the EPT leaf entry.

Once the leaf entry and IVIT entry are set up, subsequent guest writes to the doorbell MMIO address will deliver a notification interrupt to the target host thread without VMExit. If the notification bit is set in the TLB leaf entry, the processor gets the TID from the leaf entry (FIG. 6) or converts the memory write operation to memory read operation and gets TID from the memory read (FIG. 7).

The feature is “posted” because the sender agent posts the request bit in a posted interrupt descriptor, more precisely, in some embodiments, the 256-bit posted interrupt request (PIR) field of a PID, before delivering a notification interrupt to the CPU that runs the target software (e.g., a host kernel thread).

Each physical CPU is allocated a host posted interrupt (PI) descriptor which uses the same format as shown in FIG. 2. Handling of a host PI is not different than handling other regular interrupts. The host software assigns a vector to be a host PI notification vector and adds an interrupt handler (same as other interrupt handler) to the related IDT entry. The notification interrupt handler detects a specific request via the (U)PID.PIR and invokes the related callback to handle it. There may be multiple kernel threads sleeping on the same CPU and waiting to be woken up. Each of the threads can be assigned a request bit in (U)PID.PIR, and the sender CPU sets the related bit in PIR and send an IPI with the notification vector.

By way of example, there is a host thread for serving the guest network requests (e.g., assigned bit 0 from (U)PID.PIR, then PID.vector is set to 0) and another host thread for serving the guest disk requests (e.g., assigned bit 1 from (U)PID.PIR, then PID.vector is set to 1). When the guest network driver wants to notify the host network servicing thread to send out network packets from its network ring, the guest network driver writes to the virtual network device doorbell MMIO address which is translated by EPT to get the TID (assume TID=5). The sender CPU's ucode finds the PID address from the 5th entry in IVIT and sets PID.vector (i.e., 0) in (U)PID.PIR and sends PID.NV to the target CPU (i.e. PID.NDST, which is updated when the target network serving thread gets scheduled on that physical CPU) if PID.SN (suppress notification bit) is not set. The notification interrupt handler finds bit0 is set in (U)PID.PIR and finds that it corresponds to the network servicing thread (e.g., via a request-bit to thread mapping), then it wakes up the network serving thread to read packets from the guest network ring. For the disk usage, the guest disk driver writes to the virtual disk's doorbell MMIO address and gets a different TID, and the working flows is the same as above, but with a different request bit (bit 1) set in (U)PID.PIR and the notification interrupt handler will wake up the disk servicing thread to handle guest disk requests.

The above allows 256 host threads ((U)PID.PIR is 256-bit currently) share a single notification vector. This can be further extended via allocating more notification vectors, with each corresponds to a different PID allocation (i.e., PID[i].NV is set to a notification vector i). The sender (either a host kernel thread or a guest via CPU ucode operating with an IVIT entry) is assigned the corresponding PID and request bit in PIR during the initial negotiation setup.

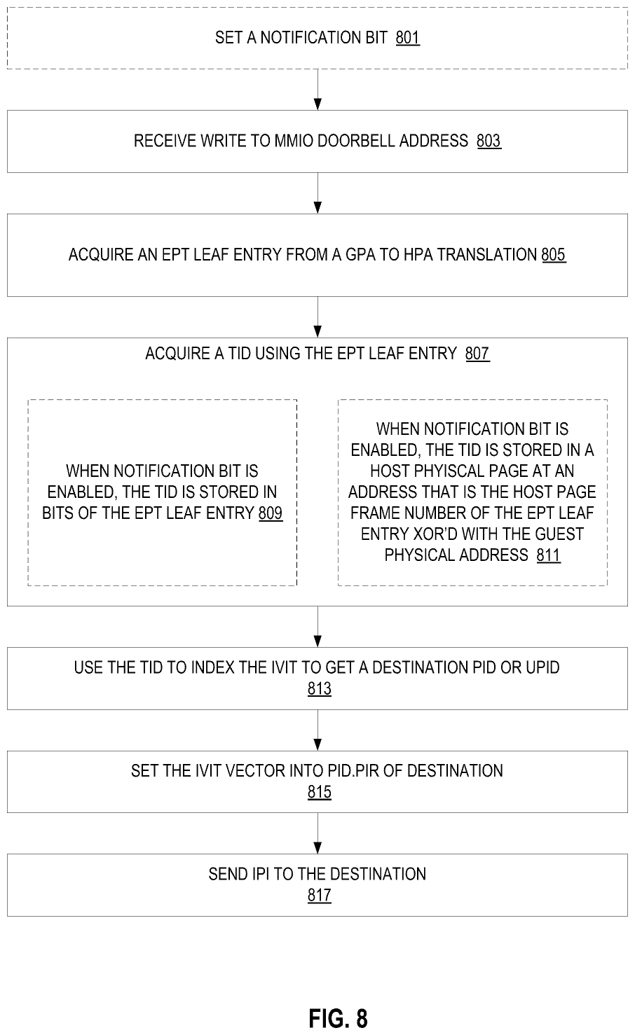

FIG. 8 illustrates embodiments of a method for using EPT-based exitless host notification. An EPT handler (software, hardware, or a combination thereof) coordinates the acts detailed below which may include accessing a VMCS, EPTP, GPA-to-HPA translation components (walker, TLB, etc.), etc.

In some embodiments, a VMM or hypervisor sets a notification bit of an EPT leaf entry at 801. As noted above, in some embodiments, this is bit 59.

A write to a MMIO doorbell address is received and translated to a guest physical address (GPA) at 803. The GPA address is used to acquire an EPT leaf entry from a GPA to HPA translation at 805.

A TID using the EPT leaf entry is acquired at 807. Note that if the notification bit is not set, the TID cannot be found using the EPT leaf entry and the remaining acts will not be performed. This acquisition may take one or two forms. In some embodiments, when the notification bit is enabled, the TID is stored in bits of the EPT leaf entry and acquired at 809. In some embodiments, when the notification bit is enabled, the TID is and acquired from a host physical page at an address that is the host page frame number of the EPT leaf entry XOR'd with the guest physical address at 811.

The TID is used index the IVIT to get a destination PID or UPID at 813. The IVIT vector is set into (U)PID.PIR of the destination (indicated by the IVIT entry) at 815. An exitless IPI is sent with a notification vector to the host destination at 817.

### Exemplary Computer Architectures

Detailed below are describes of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, handheld devices, and various other electronic devices, are also suitable. In general, a huge variety of systems or electronic devices capable of incorporating a processor and/or other execution logic as disclosed herein are generally suitable.

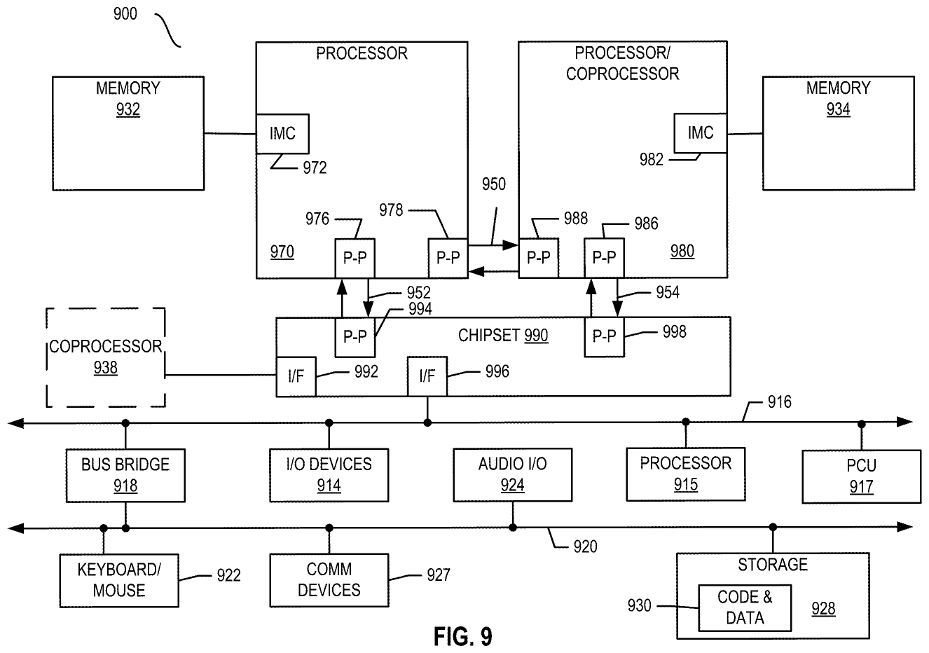

FIG. 9 illustrates embodiments of an exemplary system. Multiprocessor system 900 is a point-to-point interconnect system and includes a plurality of processors including a first processor 970 and a second processor 980 coupled via a point-to-point interconnect 950. In some embodiments, the first processor 970 and the second processor 980 are homogeneous. In some embodiments, first processor 970 and the second processor 980 are heterogenous.

Processors 970 and 980 are shown including integrated memory controller (IMC) units circuitry 972 and 982, respectively. Processor 970 also includes as part of its interconnect controller units point-to-point (P-P) interfaces 976 and 978; similarly, second processor 980 includes P-P interfaces 986 and 988. Processors 970, 980 may exchange information via the point-to-point (P-P) interconnect 950 using P-P interface circuits 978, 988. IMCs 972 and 982 couple the processors 970, 980 to respective memories, namely a memory 932 and a memory 934, which may be portions of main memory locally attached to the respective processors.

Processors 970, 980 may each exchange information with a chipset 990 via individual P-P interconnects 952, 954 using point to point interface circuits 976, 994, 986, 998. Chipset 990 may optionally exchange information with a coprocessor 938 via a high-performance interface 992. In some embodiments, the coprocessor 938 is a special-purpose processor, such as, for example, a high-throughput MIC processor, a network or communication processor, compression engine, graphics processor, GPGPU, embedded processor, or the like.

A shared cache (not shown) may be included in either processor 970, 980 or outside of both processors, yet connected with the processors via P-P interconnect, such that either or both processors' local cache information may be stored in the shared cache if a processor is placed into a low power mode.

Chipset 990 may be coupled to a first interconnect 916 via an interface 996. In some embodiments, first interconnect 916 may be a Peripheral Component Interconnect (PCI) interconnect, or an interconnect such as a PCI Express interconnect or another I/O interconnect. In some embodiments, one of the interconnects couples to a power control unit (PCU) 917, which may include circuitry, software, and/or firmware to perform power management operations with regard to the processors 970, 980 and/or co-processor 938. PCU 917 provides control information to a voltage regulator to cause the voltage regulator to generate the appropriate regulated voltage. PCU 917 also provides control information to control the operating voltage generated. In various embodiments, PCU 917 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 917 is illustrated as being present as logic separate from the processor 970 and/or processor 980. In other cases, PCU 917 may execute on a given one or more of cores (not shown) of processor 970 or 980. In some cases, PCU 917 may be implemented as a microcontroller (dedicated or general-purpose) or other control logic configured to execute its own dedicated power management code, sometimes referred to as P-code. In yet other embodiments, power management operations to be performed by PCU 917 may be implemented externally to a processor, such as by way of a separate power management integrated circuit (PMIC) or another component external to the processor. In yet other embodiments, power management operations to be performed by PCU 917 may be implemented within BIOS or other system software.

Various I/O devices 914 may be coupled to first interconnect 916, along with an interconnect (bus) bridge 918 which couples first interconnect 916 to a second interconnect 920. In some embodiments, one or more additional processor(s) 915, such as coprocessors, high-throughput MIC processors, GPGPU's, accelerators (such as, e.g., graphics accelerators or digital signal processing (DSP) units), field programmable gate arrays (FPGAs), or any other processor, are coupled to first interconnect 916. In some embodiments, second interconnect 920 may be a low pin count (LPC) interconnect. Various devices may be coupled to second interconnect 920 including, for example, a keyboard and/or mouse 922, communication devices 927 and a storage unit circuitry 928. Storage unit circuitry 928 may be a disk drive or other mass storage device which may include instructions/code and data 930, in some embodiments. Further, an audio I/O 924 may be coupled to second interconnect 920. Note that other architectures than the point-to-point architecture described above are possible. For example, instead of the point-to-point architecture, a system such as multiprocessor system 900 may implement a multi-drop interconnect or other such architecture.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die as the described CPU (sometimes referred to as the application core(s) or application processor(s)), the above described coprocessor, and additional functionality. Exemplary core architectures are described next, followed by descriptions of exemplary processors and computer architectures.

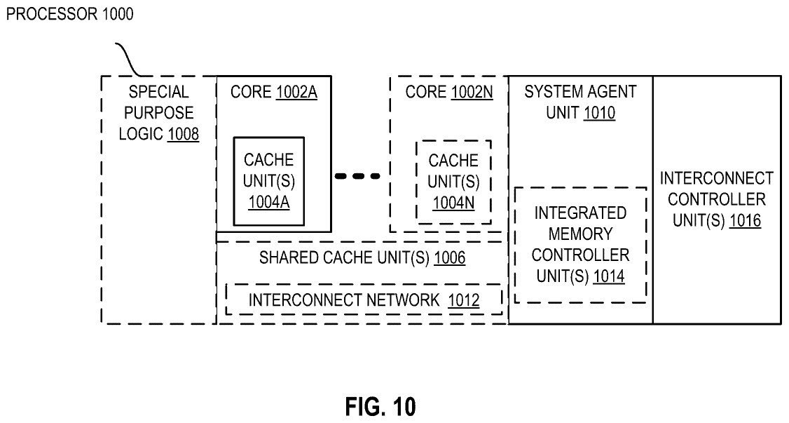

FIG. 10 illustrates a block diagram of embodiments of a processor 1000 that may have more than one core, may have an integrated memory controller, and may have integrated graphics. The solid lined boxes illustrate a processor 1000 with a single core 1002A, a system agent 1010, a set of one or more interconnect controller units circuitry 1016, while the optional addition of the dashed lined boxes illustrates an alternative processor 1000 with multiple cores 1002(A)-(N), a set of one or more integrated memory controller unit(s) circuitry 1014 in the system agent unit circuitry 1010, and special purpose logic 1008, as well as a set of one or more interconnect controller units circuitry 1016. Note that the processor 1000 may be one of the processors 970 or 980, or co-processor 938 or 915 of FIG. 9.

Thus, different implementations of the processor 1000 may include: 1) a CPU with the special purpose logic 1008 being integrated graphics and/or scientific (throughput) logic (which may include one or more cores, not shown), and the cores 1002(A)-(N) being one or more general purpose cores (e.g., general purpose in-order cores, general purpose out-of-order cores, or a combination of the two); 2) a coprocessor with the cores 1002(A)-(N) being a large number of special purpose cores intended primarily for graphics and/or scientific (throughput); and 3) a coprocessor with the cores 1002(A)-(N) being a large number of general purpose in-order cores. Thus, the processor 1000 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 1000 may be a part of and/or may be implemented on one or more substrates using any of a number of process technologies, such as, for example, BiCMOS, CMOS, or NMOS.

A memory hierarchy includes one or more levels of cache unit(s) circuitry 1004(A)-(N) within the cores 1002(A)-(N), a set of one or more shared cache units circuitry 1006, and external memory (not shown) coupled to the set of integrated memory controller units circuitry 1014. The set of one or more shared cache units circuitry 1006 may include one or more mid-level caches, such as level 2 (L2), level 3 (L3), level 4 (L4), or other levels of cache, such as a last level cache (LLC), and/or combinations thereof. While in some embodiments ring-based interconnect network circuitry 1012 interconnects the special purpose logic 1008 (e.g., integrated graphics logic), the set of shared cache units circuitry 1006, and the system agent unit circuitry 1010, alternative embodiments use any number of well-known techniques for interconnecting such units. In some embodiments, coherency is maintained between one or more of the shared cache units circuitry 1006 and cores 1002(A)-(N).

In some embodiments, one or more of the cores 1002(A)-(N) are capable of multi-threading. The system agent unit circuitry 1010 includes those components coordinating and operating cores 1002(A)-(N). The system agent unit circuitry 1010 may include, for example, power control unit (PCU) circuitry and/or display unit circuitry (not shown). The PCU may be or may include logic and components needed for regulating the power state of the cores 1002(A)-(N) and/or the special purpose logic 1008 (e.g., integrated graphics logic). The display unit circuitry is for driving one or more externally connected displays.

The cores 1002(A)-(N) may be homogenous or heterogeneous in terms of architecture instruction set; that is, two or more of the cores 1002(A)-(N) may be capable of executing the same instruction set, while other cores may be capable of executing only a subset of that instruction set or a different instruction set.

### Exemplary Core Architectures

### In-Order and Out-of-Order Core Block Diagram

FIG. 11(A) is a block diagram illustrating both an exemplary in-order pipeline and an exemplary register renaming, out-of-order issue/execution pipeline according to embodiments of the invention. FIG. 11(B) is a block diagram illustrating both an exemplary embodiment of an in-order architecture core and an exemplary register renaming, out-of-order issue/execution architecture core to be included in a processor according to embodiments of the invention. The solid lined boxes in FIGS. 11(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 11(A), a processor pipeline 1100 includes a fetch stage 1102, an optional length decode stage 1104, a decode stage 1106, an optional allocation stage 1108, an optional renaming stage 1110, a scheduling (also known as a dispatch or issue) stage 1112, an optional register read/memory read stage 1114, an execute stage 1116, a write back/memory write stage 1118, an optional exception handling stage 1122, and an optional commit stage 1124. One or more operations can be performed in each of these processor pipeline stages. For example, during the fetch stage 1102, one or more instructions are fetched from instruction memory, during the decode stage 1106, the one or more fetched instructions may be decoded, addresses (e.g., load store unit (LSU) addresses) using forwarded register ports may be generated, and branch forwarding (e.g., immediate offset or an link register (LR)) may be performed. In one embodiment, the decode stage 1106 and the register read/memory read stage 1114 may be combined into one pipeline stage. In one embodiment, during the execute stage 1116, the decoded instructions may be executed, LSU address/data pipelining to an Advanced Microcontroller Bus (AHB) interface may be performed, multiply and add operations may be performed, arithmetic operations with branch results may be performed, etc.

By way of example, the exemplary register renaming, out-of-order issue/execution core architecture may implement the pipeline 1100 as follows: 1) the instruction fetch 1138 performs the fetch and length decoding stages 1102 and 1104; 2) the decode unit circuitry 1140 performs the decode stage 1106; 3) the rename/allocator unit circuitry 1152 performs the allocation stage 1108 and renaming stage 1110; 4) the scheduler unit(s) circuitry 1156 performs the schedule stage 1112; 5) the physical register file(s) unit(s) circuitry 1158 and the memory unit circuitry 1170 perform the register read/memory read stage 1114; the execution cluster 1160 perform the execute stage 1116; 6) the memory unit circuitry 1170 and the physical register file(s) unit(s) circuitry 1158 perform the write back/memory write stage 1118; 7) various units (unit circuitry) may be involved in the exception handling stage 1122; and 8) the retirement unit circuitry 1154 and the physical register file(s) unit(s) circuitry 1158 perform the commit stage 1124.

FIG. 11(B) shows processor core 1190 including front-end unit circuitry 1130 coupled to an execution engine unit circuitry 1150, and both are coupled to a memory unit circuitry 1170. The core 1190 may be a reduced instruction set computing (RISC) core, a complex instruction set computing (CISC) core, a very long instruction word (VLIW) core, or a hybrid or alternative core type. As yet another option, the core 1190 may be a special-purpose core, such as, for example, a network or communication core, compression engine, coprocessor core, general purpose computing graphics processing unit (GPGPU) core, graphics core, or the like.

The front end unit circuitry 1130 may include branch prediction unit circuitry 1132 coupled to an instruction cache unit circuitry 1134, which is coupled to an instruction translation lookaside buffer (TLB) 1136, which is coupled to instruction fetch unit circuitry 1138, which is coupled to decode unit circuitry 1140. In one embodiment, the instruction cache unit circuitry 1134 is included in the memory unit circuitry 1170 rather than the front-end unit circuitry 1130. The decode unit circuitry 1140 (or decoder) may decode instructions, and generate as an output one or more micro-operations, micro-code entry points, microinstructions, other instructions, or other control signals, which are decoded from, or which otherwise reflect, or are derived from, the original instructions. The decode unit circuitry 1140 may further include an address generation unit circuitry (AGU, not shown). In one embodiment, the AGU generates an LSU address using forwarded register ports, and may further perform branch forwarding (e.g., immediate offset branch forwarding, LR register branch forwarding, etc.). The decode unit circuitry 1140 may be implemented using various different mechanisms. Examples of suitable mechanisms include, but are not limited to, look-up tables, hardware implementations, programmable logic arrays (PLAs), microcode read only memories (ROMs), etc. In one embodiment, the core 1190 includes a microcode ROM (not shown) or other medium that stores microcode for certain macroinstructions (e.g., in decode unit circuitry 1140 or otherwise within the front end unit circuitry 1130). In one embodiment, the decode unit circuitry 1140 includes a micro-operation (micro-op) or operation cache (not shown) to hold/cache decoded operations, micro-tags, or micro-operations generated during the decode or other stages of the processor pipeline 1100. The decode unit circuitry 1140 may be coupled to rename/allocator unit circuitry 1152 in the execution engine unit circuitry 1150.

The execution engine circuitry 1150 includes the rename/allocator unit circuitry 1152 coupled to a retirement unit circuitry 1154 and a set of one or more scheduler(s) circuitry 1156. The scheduler(s) circuitry 1156 represents any number of different schedulers, including reservations stations, central instruction window, etc. In some embodiments, the scheduler(s) circuitry 1156 can include arithmetic logic unit (ALU) scheduler/scheduling circuitry, ALU queues, arithmetic generation unit (AGU) scheduler/scheduling circuitry, AGU queues, etc. The scheduler(s) circuitry 1156 is coupled to the physical register file(s) circuitry 1158. Each of the physical register file(s) circuitry 1158 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one embodiment, the physical register file(s) unit circuitry 1158 includes vector registers unit circuitry, writemask registers unit circuitry, and scalar register unit circuitry. These register units may provide architectural vector registers, vector mask registers, general-purpose registers, etc. The physical register file(s) unit(s) circuitry 1158 is overlapped by the retirement unit circuitry 1154 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1154 and the physical register file(s) circuitry 1158 are coupled to the execution cluster(s) 1160. The execution cluster(s) 1160 includes a set of one or more execution units circuitry 1162 and a set of one or more memory access circuitry 1164. The execution units circuitry 1162 may perform various arithmetic, logic, floating-point or other types of operations (e.g., shifts, addition, subtraction, multiplication) and on various types of data (e.g., scalar floating-point, packed integer, packed floating-point, vector integer, vector floating-point). While some embodiments may include a number of execution units or execution unit circuitry dedicated to specific functions or sets of functions, other embodiments may include only one execution unit circuitry or multiple execution units/execution unit circuitry that all perform all functions. The scheduler(s) circuitry 1156, physical register file(s) unit(s) circuitry 1158, and execution cluster(s) 1160 are shown as being possibly plural because certain embodiments create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) unit circuitry, and/or execution cluster—and in the case of a separate memory access pipeline, certain embodiments are implemented in which only the execution cluster of this pipeline has the memory access unit(s) circuitry 1164). It should also be understood that where separate pipelines are used, one or more of these pipelines may be out-of-order issue/execution and the rest in-order.

In some embodiments, the execution engine unit circuitry 1150 may perform load store unit (LSU) address/data pipelining to an Advanced Microcontroller Bus (AHB) interface (not shown), and address phase and writeback, data phase load, store, and branches.

The set of memory access circuitry 1164 is coupled to the memory unit circuitry 1170, which includes data TLB unit circuitry 1172 coupled to a data cache circuitry 1174 coupled to a level 2 (L2) cache circuitry 1176. In one exemplary embodiment, the memory access units circuitry 1164 may include a load unit circuitry, a store address unit circuit, and a store data unit circuitry, each of which is coupled to the data TLB circuitry 1172 in the memory unit circuitry 1170. The instruction cache circuitry 1134 is further coupled to a level 2 (L2) cache unit circuitry 1176 in the memory unit circuitry 1170. In one embodiment, the instruction cache 1134 and the data cache 1174 are combined into a single instruction and data cache (not shown) in L2 cache unit circuitry 1176, a level 3 (L3) cache unit circuitry (not shown), and/or main memory. The L2 cache unit circuitry 1176 is coupled to one or more other levels of cache and eventually to a main memory.

The core 1190 may support one or more instructions sets (e.g., the x86 instruction set (with some extensions that have been added with newer versions); the MIPS instruction set; the ARM instruction set (with optional additional extensions such as NEON)), including the instruction(s) described herein. In one embodiment, the core 1190 includes logic to support a packed data instruction set extension (e.g., AVX1, AVX2), thereby allowing the operations used by many multimedia applications to be performed using packed data.

### Exemplary Execution Unit(s) Circuitry

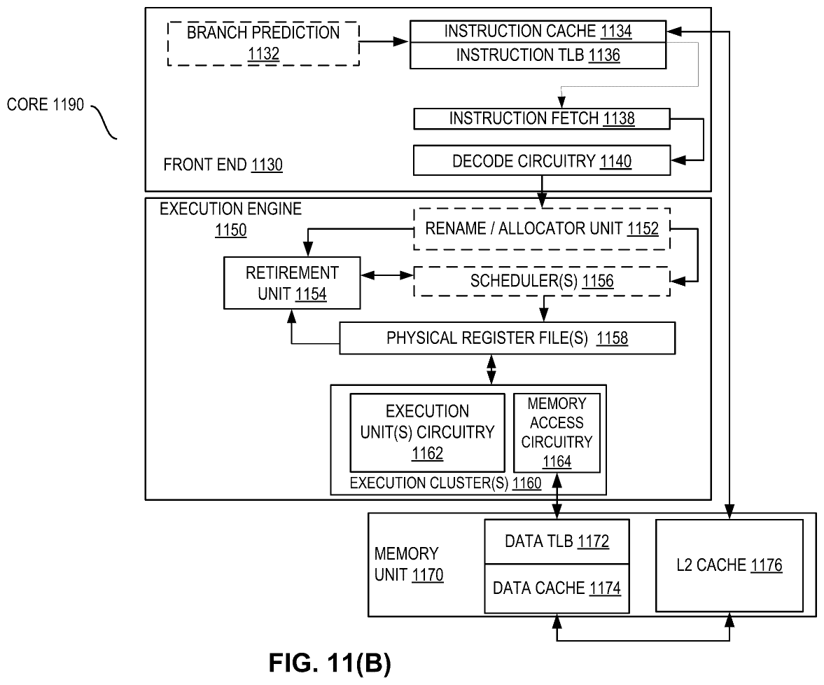

FIG. 12 illustrates embodiments of execution unit(s) circuitry, such as execution unit(s) circuitry 1162 of FIG. 11(B). As illustrated, execution unit(s) circuitry 1162 may include one or more ALU circuits 1201, vector/SIMD unit circuits 1203, load/store unit circuits 1205, and/or branch/jump unit circuits 1207. ALU circuits 1201 perform integer arithmetic and/or Boolean operations. Vector/SIMD unit circuits 1203 perform vector/SIMD operations on packed data (such as SIMD/vector registers). Load/store unit circuits 1205 execute load and store instructions to load data from memory into registers or store from registers to memory. Load/store unit circuits 1205 may also generate addresses. Branch/jump unit circuits 1207 cause a branch or jump to a memory address depending on the instruction. Floating-point unit (FPU) circuits 1209 perform floating-point arithmetic. The width of the execution unit(s) circuitry 1162 varies depending upon the embodiment and can range from 16-bit to 1,024-bit. In some embodiments, two or more smaller execution units are logically combined to form a larger execution unit (e.g., two 128-bit execution units are logically combined to form a 256-bit execution unit).

### Exemplary Register Architecture

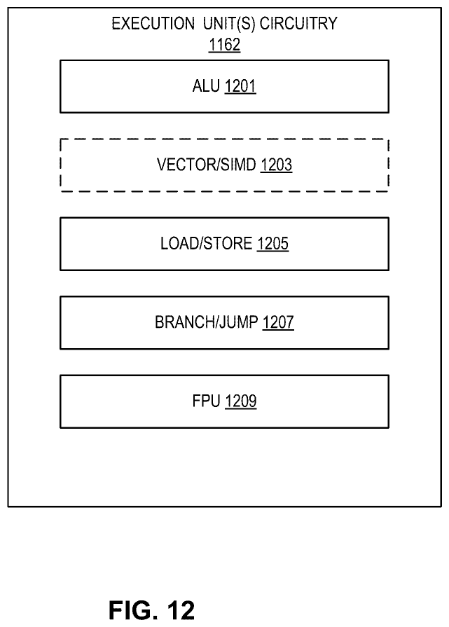

FIG. 13 is a block diagram of a register architecture 1300 according to some embodiments. As illustrated, there are vector/SIMD registers 1310 that vary from 128-bit to 1,024 bits width. In some embodiments, the vector/SIMD registers 1310 are physically 512-bits and, depending upon the mapping, only some of the lower bits are used. For example, in some embodiments, the vector/SIMD registers 1310 are ZMM registers which are 512 bits: the lower 256 bits are used for YMM registers and the lower 128 bits are used for XMM registers. As such, there is an overlay of registers. In some embodiments, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the embodiment.

In some embodiments, the register architecture 1300 includes writemask/predicate registers 1315. For example, in some embodiments, there are 8 writemask/predicate registers (sometimes called k0 through k7) that are each 16-bit, 32-bit, 64-bit, or 128-bit in size. Writemask/predicate registers 1315 may allow for merging (e.g., allowing any set of elements in the destination to be protected from updates during the execution of any operation) and/or zeroing (e.g., zeroing vector masks allow any set of elements in the destination to be zeroed during the execution of any operation). In some embodiments, each data element position in a given writemask/predicate register 1315 corresponds to a data element position of the destination. In other embodiments, the writemask/predicate registers 1315 are scalable and consists of a set number of enable bits for a given vector element (e.g., 8 enable bits per 64-bit vector element).

The register architecture 1300 includes a plurality of general-purpose registers 1325. These registers may be 16-bit, 32-bit, 64-bit, etc. and can be used for scalar operations. In some embodiments, these registers are referenced by the names RAX, RBX, RCX, RDX, RBP, RSI, RDI, RSP, and R8 through R15.

In some embodiments, the register architecture 1300 includes scalar floating-point register 1345 which is used for scalar floating-point operations on 32/64/80-bit floating-point data using the x87 instruction set extension or as MMX registers to perform operations on 64-bit packed integer data, as well as to hold operands for some operations performed between the MMX and XMM registers.

One or more flag registers 1340 (e.g., EFLAGS, RFLAGS, etc.) store status and control information for arithmetic, compare, and system operations. For example, the one or more flag registers 1340 may store condition code information such as carry, parity, auxiliary carry, zero, sign, and overflow. In some embodiments, the one or more flag registers 1340 are called program status and control registers.

Segment registers 1320 contain segment points for use in accessing memory. In some embodiments, these registers are referenced by the names CS, DS, SS, ES, FS, and GS.

Machine specific registers (MSRs) 1335 control and report on processor performance. Most MSRs 1335 handle system-related functions and are not accessible to an application program. Machine check registers 1360 consist of control, status, and error reporting MSRs that are used to detect and report on hardware errors.

One or more instruction pointer register(s) 1330 store an instruction pointer value. Control register(s) 1355 (e.g., CR0-CR4) determine the operating mode of a processor (e.g., processor 970, 980, 938, 915, and/or 1000) and the characteristics of a currently executing task. Debug registers 1350 control and allow for the monitoring of a processor or core's debugging operations.

Memory management registers 1365 specify the locations of data structures used in protected mode memory management. These registers may include a GDTR, IDRT, task register, and a LDTR register.

Alternative embodiments of the invention may use wider or narrower registers. Additionally, alternative embodiments of the invention may use more, less, or different register files and registers.

### Instruction Sets

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down though the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands.

### Exemplary Instruction Formats

Embodiments of the instruction(s) described herein may be embodied in different formats. Additionally, exemplary systems, architectures, and pipelines are detailed below. Embodiments of the instruction(s) may be executed on such systems, architectures, and pipelines, but are not limited to those detailed.

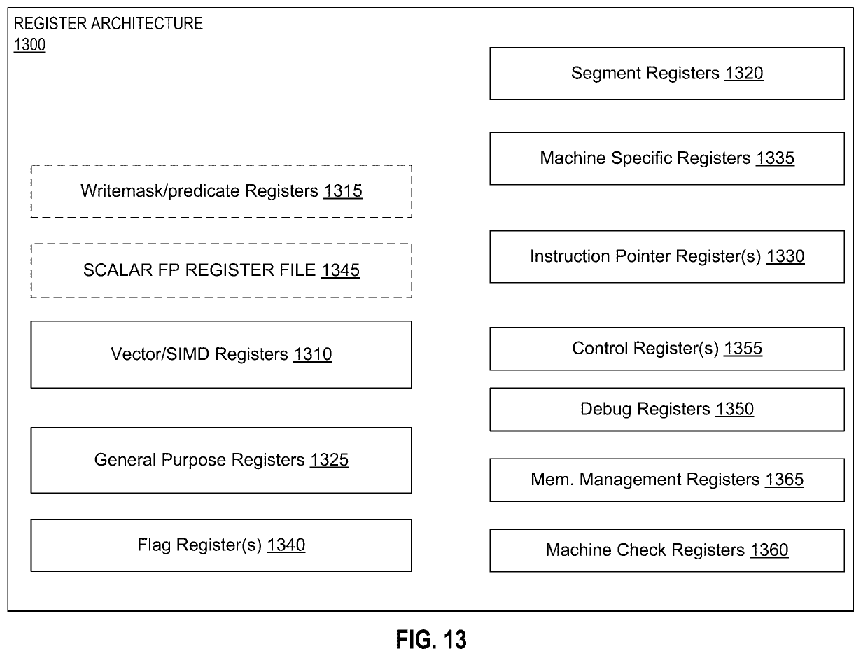

FIG. 14 illustrates embodiments of an instruction format. As illustrated, an instruction may include multiple components including, but not limited to, one or more fields for: one or more prefixes 1401, an opcode 1403, addressing information 1405 (e.g., register identifiers, memory addressing information, etc.), a displacement value 1407, and/or an immediate 1409. Note that some instructions utilize some or all of the fields of the format whereas others may only use the field for the opcode 1403. In some embodiments, the order illustrated is the order in which these fields are to be encoded, however, it should be appreciated that in other embodiments these fields may be encoded in a different order, combined, etc.

The prefix(es) field(s) 1401, when used, modifies an instruction. In some embodiments, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 1403 is used to at least partially define the operation to be performed upon a decoding of the instruction. In some embodiments, a primary opcode encoded in the opcode field 1403 is 1, 2, or 3 bytes in length. In other embodiments, a primary opcode can be a different length. An additional 3-bit opcode field is sometimes encoded in another field.

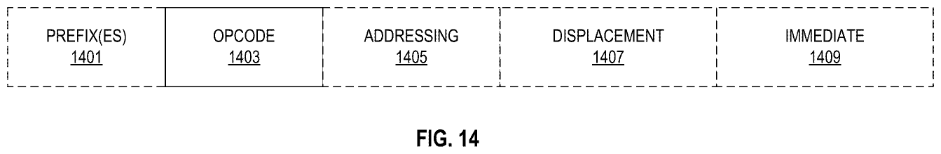

The addressing field 1405 is used to address one or more operands of the instruction, such as a location in memory or one or more registers. FIG. 15 illustrates embodiments of the addressing field 1405. In this illustration, an optional ModR/M byte 1502 and an optional Scale, Index, Base (SIB) byte 1504 are shown. The ModR/M byte 1502 and the SIB byte 1504 are used to encode up to two operands of an instruction, each of which is a direct register or effective memory address. Note that each of these fields are optional in that not all instructions include one or more of these fields. The MOD R/M byte 1502 includes a MOD field 1542, a register field 1544, and R/M field 1546.

The content of the MOD field 1542 distinguishes between memory access and non-memory access modes. In some embodiments, when the MOD field 1542 has a value of b11, a register-direct addressing mode is utilized, and otherwise register-indirect addressing is used.

The register field 1544 may encode either the destination register operand or a source register operand, or may encode an opcode extension and not be used to encode any instruction operand. The content of register index field 1544, directly or through address generation, specifies the locations of a source or destination operand (either in a register or in memory). In some embodiments, the register field 1544 is supplemented with an additional bit from a prefix (e.g., prefix 1401) to allow for greater addressing.

The R/M field 1546 may be used to encode an instruction operand that references a memory address, or may be used to encode either the destination register operand or a source register operand. Note the R/M field 1546 may be combined with the MOD field 1542 to dictate an addressing mode in some embodiments.

The SIB byte 1504 includes a scale field 1552, an index field 1554, and a base field 1556 to be used in the generation of an address. The scale field 1552 indicates scaling factor. The index field 1554 specifies an index register to use. In some embodiments, the index field 1554 is supplemented with an additional bit from a prefix (e.g., prefix 1401) to allow for greater addressing. The base field 1556 specifies a base register to use. In some embodiments, the base field 1556 is supplemented with an additional bit from a prefix (e.g., prefix 1401) to allow for greater addressing. In practice, the content of the scale field 1552 allows for the scaling of the content of the index field 1554 for memory address generation (e.g., for address generation that uses 2^{scale}*index+base).

Some addressing forms utilize a displacement value to generate a memory address. For example, a memory address may be generated according to 2scale*index+base+displacement, index*scale+displacement, r/m+displacement, instruction pointer (RIP/EIP)+displacement, register+displacement, etc. The displacement may be a 1-byte, 2-byte, 4-byte, etc. value. In some embodiments, a displacement field 1407 provides this value. Additionally, in some embodiments, a displacement factor usage is encoded in the MOD field of the addressing field 1405 that indicates a compressed displacement scheme for which a displacement value is calculated by multiplying disp8 in conjunction with a scaling factor N that is determined based on the vector length, the value of a b bit, and the input element size of the instruction. The displacement value is stored in the displacement field 1407.

In some embodiments, an immediate field 1409 specifies an immediate for the instruction. An immediate may be encoded as a 1-byte value, a 2-byte value, a 4-byte value, etc.

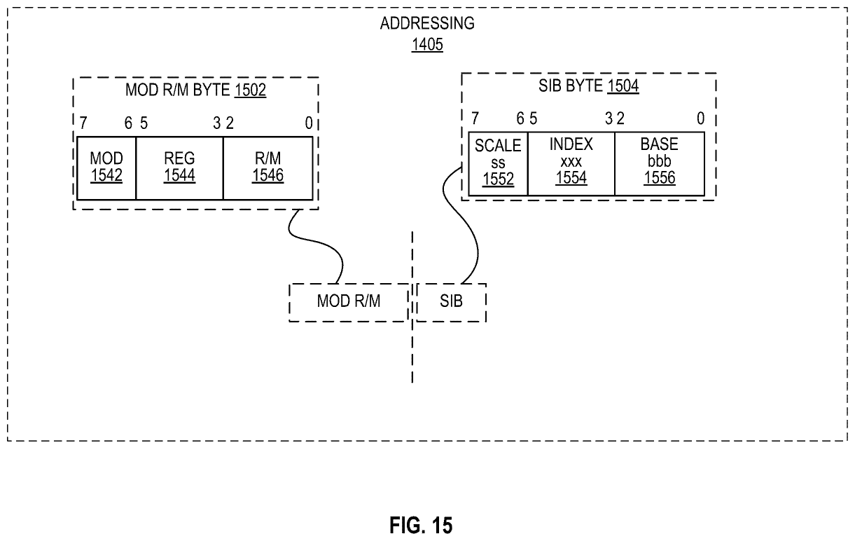

FIG. 16 illustrates embodiments of a first prefix 1401(A). In some embodiments, the first prefix 1401(A) is an embodiment of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 1401(A) may specify up to three registers using 3-bit fields depending on the format: 1) using the reg field 1544 and the R/M field 1546 of the Mod R/M byte 1502; 2) using the Mod R/M byte 1502 with the SIB byte 1504 including using the reg field 1544 and the base field 1556 and index field 1554; or 3) using the register field of an opcode.

In the first prefix 1401(A), bit positions 7:4 are set as 0100. Bit position 3 (W) can be used to determine the operand size, but may not solely determine operand width. As such, when W=0, the operand size is determined by a code segment descriptor (CS.D) and when W=1, the operand size is 64-bit.

Note that the addition of another bit allows for 16 (2⁴) registers to be addressed, whereas the MOD R/M reg field 1544 and MOD R/M R/M field 1546 alone can each only address 8 registers.

In the first prefix 1401(A), bit position 2 (R) may an extension of the MOD R/M reg field 1544 and may be used to modify the ModR/M reg field 1544 when that field encodes a general purpose register, a 64-bit packed data register (e.g., a SSE register), or a control or debug register. R is ignored when Mod R/M byte 1502 specifies other registers or defines an extended opcode.

Bit position 1 (X) X bit may modify the SIB byte index field 1554.

Bit position B (B) B may modify the base in the Mod R/M R/M field 1546 or the SIB byte base field 1556; or it may modify the opcode register field used for accessing general purpose registers (e.g., general purpose registers 1325).

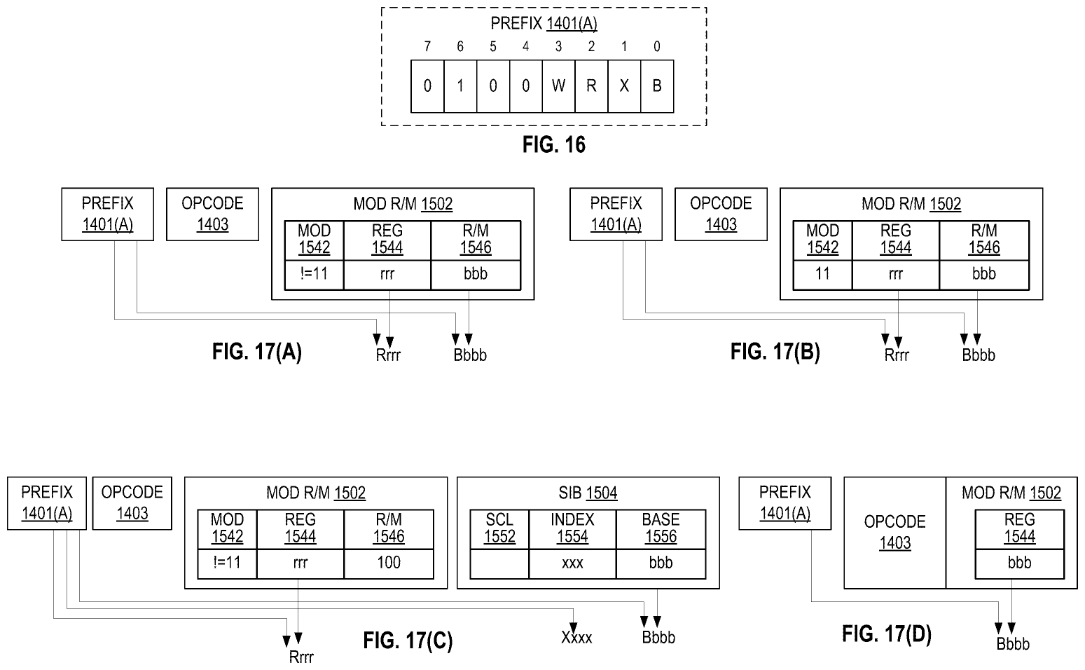

FIGS. 17(A)-(D) illustrate embodiments of how the R, X, and B fields of the first prefix 1401(A) are used. FIG. 17(A) illustrates R and B from the first prefix 1401(A) being used to extend the reg field 1544 and R/M field 1546 of the MOD R/M byte 1502 when the SIB byte 15 04 is not used for memory addressing. FIG. 17(B) illustrates R and B from the first prefix 1401(A) being used to extend the reg field 1544 and R/M field 1546 of the MOD R/M byte 1502 when the SIB byte 15 04 is not used (register-register addressing). FIG. 17(C) illustrates R, X, and B from the first prefix 1401(A) being used to extend the reg field 1544 of the MOD R/M byte 1502 and the index field 1554 and base field 1556 when the SIB byte 15 04 being used for memory addressing. FIG. 17(D) illustrates B from the first prefix 1401(A) being used to extend the reg field 1544 of the MOD R/M byte 1502 when a register is encoded in the opcode 1403.

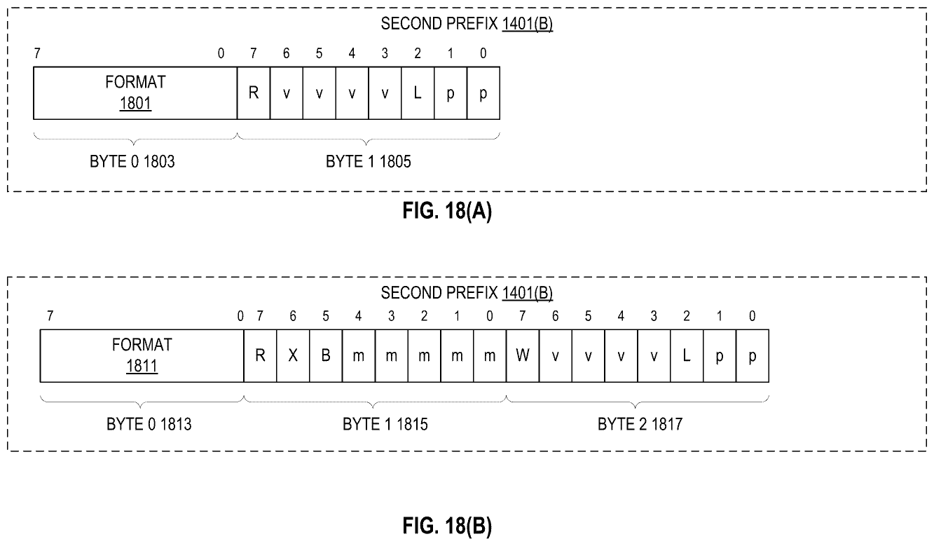

FIGS. 18(A)-(B) illustrate embodiments of a second prefix 1401(B). In some embodiments, the second prefix 1401(B) is an embodiment of a VEX prefix. The second prefix 1401(B) encoding allows instructions to have more than two operands, and allows SIMD vector registers (e.g., vector/SIMD registers 1310) to be longer than 64-bits (e.g., 128-bit and 256-bit). The use of the second prefix 1401(B) provides for three-operand (or more) syntax. For example, previous two-operand instructions performed operations such as A=A+B, which overwrites a source operand. The use of the second prefix 1401(B) enables operands to perform nondestructive operations such as A=B+C.

In some embodiments, the second prefix 1401(B) comes in two forms—a two-byte form and a three-byte form. The two-byte second prefix 1401(B) is used mainly for 128-bit, scalar, and some 256-bit instructions; while the three-byte second prefix 1401(B) provides a compact replacement of the first prefix 1401(A) and 3-byte opcode instructions.

FIG. 18(A) illustrates embodiments of a two-byte form of the second prefix 1401(B). In one example, a format field 1801 (byte 0 1803) contains the value C5H. In one example, byte 1 1805 includes a “R” value in bit[7]. This value is the complement of the same value of the first prefix 1401(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the Mod R/M R/M field 1546 to encode the instruction operand that references a memory address or encode either the destination register operand or a source register operand.

Instructions that use this prefix may use the Mod R/M reg field 1544 to encode either the destination register operand or a source register operand, be treated as an opcode extension and not used to encode any instruction operand.

For instruction syntax that support four operands, vvvv, the Mod R/M R/M field 1546 and the Mod R/M reg field 1544 encode three of the four operands. Bits[7:4] of the immediate 1409 are then used to encode the third source register operand.

FIG. 18(B) illustrates embodiments of a three-byte form of the second prefix 1401(B). in one example, a format field 1811 (byte 0 1813) contains the value C4H. Byte 1 1815 includes in bits[7:5] “R,” “X,” and “B” which are the complements of the same values of the first prefix 1401(A). Bits[4:0] of byte 1 1815 (shown as mmmmm) include content to encode, as need, one or more implied leading opcode bytes. For example, 00001 implies a 0FH leading opcode, 00010 implies a 0F38H leading opcode, 00011 implies a leading 0F3AH opcode, etc.

Bit[7] of byte 2 1817 is used similar to W of the first prefix 1401(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the Mod R/M R/M field 1546 to encode the instruction operand that references a memory address or encode either the destination register operand or a source register operand.

Instructions that use this prefix may use the Mod R/M reg field 1544 to encode either the destination register operand or a source register operand, be treated as an opcode extension and not used to encode any instruction operand.

For instruction syntax that support four operands, vvvv, the Mod R/M R/M field 1546, and the Mod R/M reg field 1544 encode three of the four operands. Bits[7:4] of the immediate 1409 are then used to encode the third source register operand.

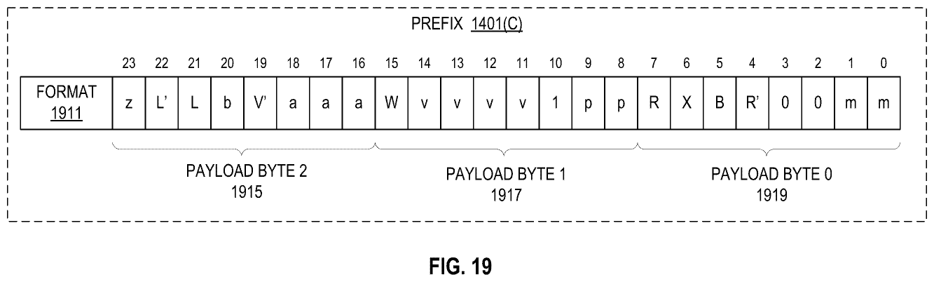

FIG. 19 illustrates embodiments of a third prefix 1401(C). In some embodiments, the first prefix 1401(A) is an embodiment of an EVEX prefix. The third prefix 1401(C) is a four-byte prefix.

The third prefix 1401(C) can encode 32 vector registers (e.g., 128-bit, 256-bit, and 512-bit registers) in 64-bit mode. In some embodiments, instructions that utilize a writemask/opmask (see discussion of registers in a previous figure, such as FIG. 13) or predication utilize this prefix. Opmask register allow for conditional processing or selection control. Opmask instructions, whose source/destination operands are opmask registers and treat the content of an opmask register as a single value, are encoded using the second prefix 1401(B).

The third prefix 1401(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 1401(C) is a format field 1911 that has a value, in one example, of 62H. Subsequent bytes are referred to as payload bytes 1915-1919 and collectively form a 24-bit value of P[23:0] providing specific capability in the form of one or more fields (detailed herein).

In some embodiments, P[1:0] of payload byte 1919 are identical to the low two mmmmm bits. P[3:2] are reserved in some embodiments. Bit P[4] (R′) allows access to the high 16 vector register set when combined with P[7] and the ModR/M reg field 1544. P[6] can also provide access to a high 16 vector register when SIB-type addressing is not needed. P[7:5] consist of an R, X, and B which are operand specifier modifier bits for vector register, general purpose register, memory addressing and allow access to the next set of 8 registers beyond the low 8 registers when combined with the ModR/M register field 1544 and ModR/M R/M field 1546. P[9:8] provide opcode extensionality equivalent to some legacy prefixes (e.g., 00=no prefix, 01=66H, 10=F3H, and 11=F2H). P[10] in some embodiments is a fixed value of 1. P[14:11], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

P[15] is similar to W of the first prefix 1401(A) and second prefix 1411(B) and may serve as an opcode extension bit or operand size promotion.

P[18:16] specify the index of a register in the opmask (writemask) registers (e.g., writemask/predicate registers 1315). In one embodiment of the invention, the specific value aaa=000 has a special behavior implying no opmask is used for the particular instruction (this may be implemented in a variety of ways including the use of an opmask hardwired to all ones or hardware that bypasses the masking hardware). When merging, vector masks allow any set of elements in the destination to be protected from updates during the execution of any operation (specified by the base operation and the augmentation operation); in other one embodiment, preserving the old value of each element of the destination where the corresponding mask bit has a 0. In contrast, when zeroing vector masks allow any set of elements in the destination to be zeroed during the execution of any operation (specified by the base operation and the augmentation operation); in one embodiment, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While embodiments of the invention are described in which the opmask field's content selects one of a number of opmask registers that contains the opmask to be used (and thus the opmask field's content indirectly identifies that masking to be performed), alternative embodiments instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differs across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Exemplary embodiments of encoding of registers in instructions using the third prefix 1401(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R′ | R | ModR/M | GPR, Vector | Destination or Source |
| | | | reg | | |
| VVVV | V′ | vvvv | | GPR, Vector | 2nd Source or Destination |
| RM | X | B | ModR/M | GPR, Vector | 1st Source or Destination |
| | | | R/M | | |
| BASE | 0 | B | ModR/M | GPR | Memory addressing |
| | | | R/M | | |
| INDEX | 0 | X | SIB.index | GPR | Memory addressing |
| VIDX | V′ | X | SIB.index | Vector | VSIB memory addressing |

TABLE 2
Encoding Register Specifiers in 32-bit Mode

| | [2:0] | REG. TYPE | COMMON USAGES |
|---|---|---|---|
| REG | ModR/M reg | GPR, Vector | Destination or Source |
| VVVV | vvvv | GPR, Vector | 2^{nd} Source or Destination |
| RM | ModR/M R/M | GPR, Vector | 1^{st} Source or Destination |
| BASE | ModR/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | ModR/M Reg | k0-k7 | Source |
| VVVV | vvvv | k0-k7 | 2^{nd} Source |
| RM | ModR/M R/M | k0-7 | 1^{st} Source |
| {k1] | aaa | k0¹-k7 | Opmask |

Program code may be applied to input instructions to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), or a microprocessor.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

### Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

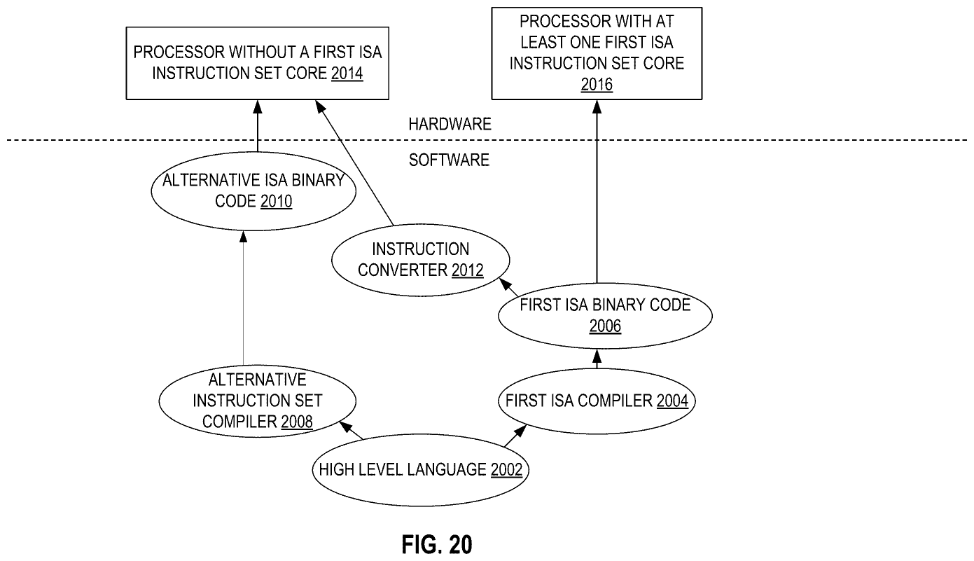

FIG. 20 illustrates a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 20 shows a program in a high-level language 2002 may be compiled using a first ISA compiler 2004 to generate first ISA binary code 2006 that may be natively executed by a processor with at least one first instruction set core 2016. The processor with at least one first ISA instruction set core 2016 represents any processor that can perform substantially the same functions as an Intel® processor with at least one first ISA instruction set core by compatibly executing or otherwise processing (1) a substantial portion of the instruction set of the first ISA instruction set core or (2) object code versions of applications or other software targeted to run on an Intel processor with at least one first ISA instruction set core, in order to achieve substantially the same result as a processor with at least one first ISA instruction set core. The first ISA compiler 2004 represents a compiler that is operable to generate first ISA binary code 2006 (e.g., object code) that can, with or without additional linkage processing, be executed on the processor with at least one first ISA instruction set core 2016. Similarly, FIG. 20 shows the program in the high-level language 2002 may be compiled using an alternative instruction set compiler 2008 to generate alternative instruction set binary code 2010 that may be natively executed by a processor without a first ISA instruction set core 2014. The instruction converter 2012 is used to convert the first ISA binary code 2006 into code that may be natively executed by the processor without a first ISA instruction set core 2014. This converted code is not likely to be the same as the alternative instruction set binary code 2010 because an instruction converter capable of this is difficult to make; however, the converted code will accomplish the general operation and be made up of instructions from the alternative instruction set. Thus, the instruction converter 2012 represents software, firmware, hardware, or a combination thereof that, through emulation, simulation or any other process, allows a processor or other electronic device that does not have a first ISA instruction set processor or core to execute the first ISA binary code 2006.

References to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Moreover, in the various embodiments described above, unless specifically noted otherwise, disjunctive language such as the phrase “at least one of A, B, or C” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

Exemplary embodiments include, but are not limited to:

1. An apparatus comprising:
decoder circuitry to decode a single instruction, the single instruction to include a field for an opcode; and
execution processing resources to execute the decoded single instruction according to the at least the opcode to cause an exitless guest to host notification from a virtual processor to a physical or virtual processor.
   2. The apparatus of example 1, wherein the opcode of the instruction is to indicate is a virtual machine function instruction and an implicit register value is to indicate exitless guest to host notification from a virtual processor to a physical or virtual processor.
   3. The apparatus of examples 1-2, wherein the execution processing resources, in response to the decoded single instruction, are further to index an inter-virtual machine inter-processor interrupt (IVIT) data structure using an index to acquire a destination identifier from an entry of the IVIT data structure, set a vector value in a posted-interrupt requests field of the destination as indicated by the entry of the IVIT data structure, and send an inter-processor interrupt with physical vector as identified in a descriptor to a destination processor.
   4. The apparatus of example 3, wherein the destination identifier is an address of a posted interrupt descriptor.
   5. The apparatus of example 3, wherein the destination identifier is an address of a user posted interrupt descriptor.
   6. The apparatus of example 3, wherein an index is to be provided by a field of the instruction.
   7. The apparatus of example 3, wherein the inter-processor interrupt is to be sent to an programmable interrupt controller.
   8. A method comprising:
decoding a single instruction, the single instruction to include a field for an opcode; and
processing the decoded single instruction according to the at least the opcode to cause an exitless guest to host notification from a virtual processor to a physical or virtual processor.

9. The method of example 8, wherein the opcode of the instruction is to indicate is a virtual machine function instruction and an implicit register value is to indicate exitless guest to host notification from a virtual processor to a physical or virtual processor.

10. The method of examples 8-9, wherein the processing further comprises:
indexing an inter-virtual machine inter-processor interrupt (IVIT) data structure using an index to acquire a destination identifier from an entry of the IVIT data structure,
setting a vector value in a posted-interrupt requests field of the destination as indicated by the entry of the IVIT data structure, and
sending an inter-processor interrupt with physical vector to a destination processor.
   11. The method of example 10, wherein the destination identifier is an address of a posted interrupt descriptor.
   12. The method of example 10, wherein the destination identifier is an address of a user posted interrupt descriptor.
   13. The method of example 10, wherein an index is to be provided by a field of the instruction.
   14. The method of example 10, wherein the inter-processor interrupt sent to an programmable interrupt controller.
   15. A method comprising:
translating a single instruction from a first instruction set architecture into one or more instructions of a second instruction set architecture, the single instruction to include a field for an opcode;
decoding the one or more instructions of the second instruction set architecture; and
processing the decoded single instruction according to the at least the opcode to cause an exitless guest to host notification from a virtual processor to a physical or virtual processor.
   16. The method of example 15, wherein the opcode of the instruction is to indicate is a virtual machine function instruction and an implicit register value is to indicate exitless guest to host notification from a virtual processor to a physical or virtual processor.
   17. The method of example 15, processing further comprises:
indexing an inter-virtual machine inter-processor interrupt (IVIT) data structure using an index to acquire a destination identifier from an entry of the IVIT data structure,
setting a vector value in a posted-interrupt requests field of the destination as indicated by the entry of the IVIT data structure, and sending an inter-processor interrupt with physical vector to a destination processor.
   18. A system comprising:
a first processor core including:
   decoder circuitry to decode a single instruction, the single instruction to include a field for an opcode; and
   execution processing resources to execute the decoded single instruction according to the at least the opcode to cause an exitless guest to host notification from a virtual processor to a second processor core; and
memory coupled to the processor core to store the single instruction.
   19. The system of example 18, wherein the execution processing resources, in response to the decoded single instruction, are further to index an inter-virtual machine inter-processor interrupt (IVIT) data structure using an index to acquire a destination identifier from an entry of the IVIT data structure, set a vector value in a posted-interrupt requests field of the destination as indicated by the entry of the IVIT data structure, and send an inter-processor interrupt with physical vector to a destination processor.
   20. The system of examples 18-19, wherein the inter-processor interrupt sent to a programmable interrupt controller of the second processor core.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
decoder circuitry to decode a single instruction, the single instruction to include a field for an opcode; and
execution processing resources to execute the decoded single instruction according to the at least the opcode to cause an exitless guest to host notification from a virtual processor to a physical or virtual processor.

2. The apparatus of claim 1, wherein the opcode of the instruction is to indicate is a virtual machine function instruction and an implicit register value is to indicate exitless guest to host notification from a virtual processor to a physical or virtual processor.

3. The apparatus of claim 1, wherein the execution processing resources, in response to the decoded single instruction, are further to index an inter-virtual machine inter-processor interrupt (IVIT) data structure using an index to acquire a destination identifier from an entry of the IVIT data structure, set a vector value in a posted-interrupt requests field of the destination as indicated by the entry of the IVIT data structure, and send an inter-processor interrupt with physical vector as identified in a descriptor to a destination processor.

4. The apparatus of claim 3, wherein the destination identifier is an address of a posted interrupt descriptor.

5. The apparatus of claim 3, wherein the destination identifier is an address of a user posted interrupt descriptor.

6. The apparatus of claim 3, wherein an index is to be provided by a field of the instruction.

7. The apparatus of claim 3, wherein the inter-processor interrupt is to be sent to an programmable interrupt controller.

8. A method comprising:
decoding a single instruction, the single instruction to include a field for an opcode; and
processing the decoded single instruction according to the at least the opcode to cause an exitless guest to host notification from a virtual processor to a physical or virtual processor.

9. The method of claim 8, wherein the opcode of the instruction is to indicate is a virtual machine function instruction and an implicit register value is to indicate exitless guest to host notification from a virtual processor to a physical or virtual processor.

10. The method of claim 8, wherein the processing further comprises:
indexing an inter-virtual machine inter-processor interrupt (IVIT) data structure using an index to acquire a destination identifier from an entry of the IVIT data structure,
setting a vector value in a posted-interrupt requests field of the destination as indicated by the entry of the IVIT data structure, and
sending an inter-processor interrupt with physical vector to a destination processor.

11. The method of claim 10, wherein the destination identifier is an address of a posted interrupt descriptor.

12. The method of claim 10, wherein the destination identifier is an address of a user posted interrupt descriptor.

13. The method of claim 10, wherein an index is to be provided by a field of the instruction.

14. The method of claim 10, wherein the inter-processor interrupt sent to an programmable interrupt controller.

15. A method comprising:
translating a single instruction from a first instruction set architecture into one or more instructions of a second instruction set architecture, the single instruction to include a field for an opcode;
decoding the one or more instructions of the second instruction set architecture; and
processing the decoded single instruction according to the at least the opcode to cause an exitless guest to host notification from a virtual processor to a physical or virtual processor.

16. The method of claim 15, wherein the opcode of the instruction is to indicate is a virtual machine function instruction and an implicit register value is to indicate exitless guest to host notification from a virtual processor to a physical or virtual processor.

17. The method of claim 15, processing further comprises:
indexing an inter-virtual machine inter-processor interrupt (IVIT) data structure using an index to acquire a destination identifier from an entry of the IVIT data structure,
setting a vector value in a posted-interrupt requests field of the destination as indicated by the entry of the IVIT data structure, and
sending an inter-processor interrupt with physical vector to a destination processor.

18. A system comprising:
a first processor core including:
decoder circuitry to decode a single instruction, the single instruction to include a field for an opcode; and
execution processing resources to execute the decoded single instruction according to the at least the opcode to cause an exitless guest to host notification from a virtual processor to a second processor core; and
memory coupled to the processor core to store the single instruction.

19. The system of claim 18, wherein the execution processing resources, in response to the decoded single instruction, are further to index an inter-virtual machine inter-processor interrupt (IVIT) data structure using an index to acquire a destination identifier from an entry of the IVIT data structure, set a vector value in a posted-interrupt requests field of the destination as indicated by the entry of the IVIT data structure, and send an inter-processor interrupt with physical vector to a destination processor.

20. The system of claim 19, wherein the inter-processor interrupt is to be sent to a programmable interrupt controller of the second processor core.
